(19) United States
(12) Patent Application Publication
(10) Pub. No.: US 2026/0370409 A1
(43) Pub. Date: Nov. 19, 2026

(54) METHOD AND APPARATUS IN NODE USED FOR REFERENCE SIGNAL TRANSMISSION IN WIRELESS COMMUNICATION

(71) Applicant: Honor Device Co., Ltd., Shenzhen (CN)

(72) Inventors: Qi JIANG, Shenzhen (CN); Ping WANG, Shenzhen (CN); Xiaobo ZHANG, Shenzhen (CN)

(21) Appl. No.: 19/734,536

(22) Filed: Jul. 8, 2026

Related U.S. Application Data
(63) Continuation of application No. PCT/CN2025/071428, filed on Jan. 9, 2025.

(30) Foreign Application Priority Data
Jan. 10, 2024 (CN) 202410038606.8

(51) Int. Cl. H04L 5/00; H04B 17/309

(52) U.S. Cl. CPC H04L 5/005; H04B 17/347

(57) ABSTRACT

This application discloses a method and apparatus in a node used for reference signal transmission in wireless communication. A first node receives first signaling, where the first signaling indicates a first reference signal resource; and receives second signaling and a first reference signal, where whether the first reference signal can be jointly used with another reference signal received in the first reference signal resource for path loss calculation depends on the second signaling. A resource element occupied by the first reference signal in a time unit in which the first reference signal is located belongs to the first reference signal resource. This application can support an integrated sensing and communication technology with low modification costs to an existing network, to achieve integration of communication and sensing, implement a function of sensing-assisted communication, reduce a probability that path loss is affected by an outlier.

### CROSS-REFERENCE TO RELATED APPLICATIONS

This application is a continuation of International Application No. PCT/CN2025/071428, filed on Jan. 9, 2025, which claims priority to Chinese Patent Application No. 202410038606.8, filed on Jan. 10, 2024, both of which are incorporated herein by reference in their entireties.

### TECHNICAL FIELD

This application relates to a reference signal transmission method and apparatus in a wireless communication system, and in particular, to a method and apparatus for path loss.

### BACKGROUND

With the development of mobile communication, especially application of a 5G active antenna array, architectures of a communication system and a sensing system tend to be consistent, and an integrated trend of communication and a sensing capability in a network gradually becomes obvious. An integrated sensing and communication technology, namely, integrated sensing and communication (Integrated Sensing And Communication, ISAC) technology, refers to implementation of a unified design of communication and sensing functions through a joint air interface and protocol design, spatio-temporal-frequency resource multiplexing, hardware device sharing, and the like. This enables a wireless network to perform high-quality communication interaction while simultaneously implementing a high-precision, fine-grained sensing function, thereby improving system spectral efficiency, energy efficiency, and hardware efficiency, and obtaining an integration gain (integration gain). In addition, mutual assistance and collaboration between communication and sensing functions can also enhance performance of both, thereby obtaining a coordination gain (coordination gain).

In the 5 G Rel-18(Release-18, Release-18) stage, 3GPP (the 3rd Generation Partnership Project, the 3rd Generation Partnership Project) SA1 (Services & Systems Aspects 1, Services & Systems Aspects 1) has carried out extensive and comprehensive ISAC scenario use case studies. In June 2023, the Feasibility Study on Integrated Sensing and Communication (Feasibility Study on Integrated Sensing and Communication) technical report (Technical Report, TR) 22.837(Rel-19 ) approved at the 3 GPP SA#100 plenary meeting describes 32 use cases in total across three major scenarios: object detection and tracking (object detection and tracking), environment monitoring (environment monitoring), and motion monitoring (motion monitoring). In December 2023, the 3GPP RAN (Radio Access Network, radio access network) #102 plenary meeting approved the SI (Study Item, study item) “Study on channel modelling for Integrated Sensing And Communication (ISAC) for NR (Study on channel modelling for ISAC for NR)”. In the Rel-19 stage, the RAN1 working group also takes supporting the object detection and tracking scenario as a goal, and taking a channel model in 38.901 as a starting point, to lead research on ISAC channel modeling and the like. ISAC is also regarded as one of the key potential technical development directions and one of six main application scenarios in the 6G stage.

### SUMMARY

In a wireless communication system, power divergence of a radio signal and a wireless propagation environment between a transmitter and a receiver lead to path loss. Link budget is an important tool in a wireless system design, and path loss is one of the main factors affecting the link budget. In NR, a UE (User Equipment, user equipment) obtains a path loss value by calculating a difference between transmission power and RSRP (Reference Signal Received Power, reference signal received power) of a reference signal. The RSRP is RSRP filtered based on a higher layer (higher layer), to avoid excessive fluctuations in the link budget caused by frequent or drastic changes in path loss. However, presence of a filter coefficient (filter coefficient) during higher layer filtering may cause the higher-layer filtered RSRP to be affected by an extreme value or an outlier for a long time.

Compared to a communication-only system, a sensing system in ISAC can implement rapid sensing of a distance, a location, and a movement speed of a target node, thereby determining wireless propagation environments in different beam directions, such as whether there is a transient beam blockage on a UE movement path. A communication system in ISAC can adjust communication configuration based on a sensing result in a timely manner, such as optimizing path loss calculation to reduce an increase of uplink transmission power caused by the transient beam blockage. Therefore, enhancing path loss calculation with a sensing result in an ISAC scenario to improve system stability and reliability is a problem worth studying.

In response to the foregoing problem, this application discloses a solution. It should be noted that, in the foregoing problem descriptions, an NR (New Radio, new radio) system is used as an example, and this application is also applicable to a scenario such as a future 6G system, to achieve similar technical effects as the NR system. Further, although an original intention of this application is for the ISAC scenario, this application can also be applied to other non-ISAC scenarios. Moreover, adopting a unified design scheme for different scenarios (such as the other non-ISAC scenarios, including but not limited to an RIS (Reconfigurable Intelligent Surface, reconfigurable intelligent surface), vehicle to everything (Vehicle to Everything, V2X), a sidelink (SideLink, SL), an NCR (Network Control Repeater, network controlled repeater) capacity enhancement system, a short-range communication system, an NTN (Non Terrestrial Network, non-terrestrial network), IoT (Internet of Things, internet of things), a URLLC (Ultra Reliable Low Latency Communication, ultra-reliable low-latency communications) network, and the like) also helps to reduce hardware complexity and costs. In a case of no conflict, embodiments of any node and features in the embodiments of this application may be applied to any other node. In a case of no conflict, embodiments and features in the embodiments of this application may be arbitrarily combined with each other.

In particular, for the interpretation of terminology (Terminology), nouns, functions, and variables in this application (unless otherwise explicitly stated), refer to the definitions in the TS38 series and the TS37 series in the 3GPP technical specification (Technical Specification, TS). If necessary, refer to TS38.211, TS38.212, TS38.213, TS38.214, TS38.215, TS38.300, TS38.304, TS38.305, TS38.321, TS38.331, TS37.355, and TS38.423 in the 3GPP technical specification to assist in understanding this application.

In an embodiment, for the interpretation of the terminology in this application, refer to the definitions in the 3GPP specification protocol TS38 series.

In an embodiment, for the interpretation of the terminology in this application, refer to the definitions in the 3GPP specification protocol TS37 series.

In an embodiment, for the interpretation of the terminology in this application, refer to the definitions in the 3GPP specification protocol TS40 series.

In an embodiment, for the interpretation of the terminology in this application, refer to the definitions in the 3GPP specification protocol TS39 series.

This application discloses a method in a first node used for reference signal transmission in wireless communication, including:
receiving first signaling, where the first signaling indicates a first reference signal resource; and receiving second signaling and a first reference signal, where whether the first reference signal can be jointly used with another reference signal received in the first reference signal resource for path loss calculation depends on the second signaling.

A resource element occupied by the first reference signal in a time unit in which the first reference signal is located belongs to the first reference signal resource.

In an embodiment, a problem to be resolved by this application includes: how to determine path loss in uplink power control.

In an embodiment, a problem to be resolved by this application includes: whether the first reference signal can be jointly used with the another reference signal received in the first reference signal resource for path loss calculation.

In an embodiment, a problem to be resolved by this application includes: power control in an ISAC scenario.

In an embodiment, a problem to be resolved by this application includes: how to determine path loss in uplink power control in an ISAC scenario.

In an embodiment, a characteristic of the foregoing method includes: The first node in this application receives the second signaling and determines, through the second signaling, whether the first reference signal can be jointly used with the another reference signal received in the first reference signal resource for path loss calculation, thereby resolving the foregoing problem.

In an embodiment, a characteristic of the foregoing method includes: The first node receives the first reference signal in the first reference signal resource based on configuration information of the first reference signal resource.

In an embodiment, a characteristic of the foregoing method includes: The first reference signal is single reference signal transmission of the first reference signal resource.

In an embodiment, a characteristic of the foregoing method includes: The first reference signal is single reference signal transmission of the first reference signal resource in a time unit.

In an embodiment, a characteristic of the foregoing method includes: The first reference signal resource includes the first reference signal.

In an embodiment, a characteristic of the foregoing method includes: The second signaling is dynamic signaling.

In an embodiment, a characteristic of the foregoing method includes: The second signaling directly or explicitly indicates whether the first reference signal can be jointly used with the another reference signal received in the first reference signal resource for path loss calculation.

In an embodiment, a characteristic of the foregoing method includes: The second signaling indirectly or implicitly indicates whether the first reference signal can be jointly used with the another reference signal received in the first reference signal resource for path loss calculation.

In an embodiment, a characteristic of the foregoing method includes: The resource element occupies one multicarrier symbol in time domain and one subcarrier in frequency domain.

In an embodiment, a benefit of the foregoing method includes: This application supports an ISAC technology, so that a wireless network can perform high-quality communication interaction while simultaneously implementing a high-precision, fine-grained sensing function, thereby improving system spectral efficiency, energy efficiency, and hardware efficiency and obtaining an integration gain.

In an embodiment, a benefit of the foregoing method includes: A dynamic signaling indication is beneficial for adapting to a rapidly changing environment.

In an embodiment, a benefit of the foregoing method includes: It is beneficial for a system to appropriately adjust uplink transmission power and reduce power adjustment fluctuations.

In an embodiment, a benefit of the foregoing method includes: A power adjustment delay can be reduced by using a signaling indication, thereby improving system stability.

In an embodiment, a benefit of the foregoing method includes: more precisely adjusting transmission power of an uplink wireless signal, and ensuring reliable signal transmission while simultaneously reducing terminal power consumption.

According to one aspect of this application, the foregoing method includes:
receiving a first information block, where the first information block indicates a first time unit set.

The time unit in which the first reference signal is located is a time unit in the first time unit set, and the first time unit set depends on a spatial relation of the first reference signal resource.

In an embodiment, a problem to be resolved by this application includes: how the first node determines the first time unit set.

In an embodiment, a problem to be resolved by this application includes: how the first node determines the first reference signal.

In an embodiment, a characteristic of the foregoing method includes: In this application, the first node determines the first time unit set by receiving the first information block, and the time unit in which the first reference signal is located is a time unit of the first time unit set, thereby resolving the foregoing problem.

In an embodiment, a characteristic of the foregoing method includes: The first time unit set is configured for the spatial relation of the first reference signal resource.

In an embodiment, a characteristic of the foregoing method includes: The first time unit set is determined based on the spatial relation of the first reference signal resource.

In an embodiment, a characteristic of the foregoing method includes: The first time unit set occupies consecutive time domain resources.

In an embodiment, a characteristic of the foregoing method includes: The time domain resources occupied by the first time unit set overlap with time domain resources occupied by the first reference signal resource set.

In an embodiment, a benefit of the foregoing method includes: The first time unit set indicated by the first information block is easy to implement.

In an embodiment, a benefit of the foregoing method includes: more precisely determining the first time unit set.

In an embodiment, a benefit of the foregoing method includes: It is beneficial for reasonably optimizing path loss calculation based on a beam direction and improving reliability of system transmission.

According to one aspect of this application, the foregoing method is characterized in that a sender of the first signaling determines the first time unit set based on a sensing signal.

In an embodiment, a problem to be resolved by this application includes: how the sender of the first signaling determines the first time unit set.

In an embodiment, a characteristic of the foregoing method includes: The sender of the first signaling in this application determines the first time unit set based on the sensing signal, thereby resolving the foregoing problem.

In an embodiment, a characteristic of the foregoing method includes: The first time unit set is predicted by the sender of the first signaling based on a sensing result of the sensing signal.

In an embodiment, a characteristic of the foregoing method includes: The sender of the first signaling determines the first time unit set based on the sensing signal in an implementation-related manner.

In an embodiment, a characteristic of the foregoing method includes: The sender of the first signaling assumes that a beam blockage may occur in a beam direction of a reference signal transmitted in the first time unit set.

In an embodiment, a characteristic of the foregoing method includes: The sender of the first signaling is a second node in this application.

In an embodiment, a benefit of the foregoing method includes: optimizing path loss calculation to reduce an increase of uplink transmission power caused by a transient beam blockage, thereby improving a terminal battery life and saving energy.

In an embodiment, a benefit of the foregoing method includes: implementing sensing-assisted communication in an ISAC system, thereby improving communication performance and obtaining a coordination gain.

In an embodiment, a benefit of the foregoing method includes: reasonably predicting time when L1-RSRP may have an outlier based on the sensing signal, reducing a probability that path loss is affected by the outlier, and facilitating a correct estimation of path loss.

According to one aspect of this application, the foregoing method is characterized in that when the second signaling indicates the time unit in which the first reference signal is located, and the spatial relation of the first reference signal resource is associated with a candidate reference signal resource set, the first reference signal cannot be jointly used with the another reference signal received in the first reference signal resource for path loss calculation.

In an embodiment, a problem to be resolved by this application includes: how to determine, based on the second signaling, whether the first reference signal can be jointly used with the another reference signal received in the first reference signal resource for path loss calculation.

In an embodiment, a characteristic of the foregoing method includes: In this application, when the second signaling indicates the time unit in which the first reference signal is located, and the spatial relation of the first reference signal resource is associated with the candidate reference signal resource set, the first reference signal cannot be jointly used with the another reference signal received in the first reference signal resource for path loss calculation.

In an embodiment, a characteristic of the foregoing method includes: In this application, the second signaling indicates a time domain resource of a reference signal that cannot be jointly used with the another reference signal for path loss, and the time domain resource includes the time unit in which the first reference signal is located.

In an embodiment, a characteristic of the foregoing method includes: A beam direction of the first reference signal resource is the same as a beam direction of a sensing signal.

In an embodiment, a benefit of the foregoing method includes: optimizing path loss calculation to reduce an increase of uplink transmission power caused by a transient beam blockage, thereby improving a terminal battery life and saving energy.

In an embodiment, a benefit of the foregoing method includes: good backward compatibility.

According to one aspect of this application, the foregoing method is characterized in that the second signaling indicates a first resource element set, and a value of a symbol transmitted in a resource element in the first resource element set depends on a first waveform; and the second signaling indicates that the spatial relation of the first reference signal resource is associated with a candidate reference signal resource set, and the first reference signal cannot be jointly used with the another reference signal received in the first reference signal resource for path loss calculation.

In an embodiment, a problem to be resolved by this application includes: how to determine, based on the second signaling, whether the first reference signal can be jointly used with the another reference signal received in the first reference signal resource for path loss calculation.

In an embodiment, a characteristic of the foregoing method includes: In this application, when the second signaling indicates a resource element in which the sensing signal is located, and the spatial relation of the first reference signal resource is associated with the candidate reference signal resource set, the first reference signal cannot be jointly used with the another reference signal received in the first reference signal resource for path loss calculation.

In an embodiment, a characteristic of the foregoing method includes: The resource element in the first resource element set is used for sensing.

In an embodiment, a characteristic of the foregoing method includes: A beam direction of the first reference signal resource is the same as a beam direction of a sensing signal.

In an embodiment, a benefit of the foregoing method includes: implementing communication-assisted sensing in an ISAC system, thereby improving sensing efficiency and sensing performance and obtaining a coordination gain.

In an embodiment, a benefit of the foregoing method includes: helping to avoid a conflict between a sensing task and another communication task, optimizing resource utilization, and improving overall network performance.

In an embodiment, a benefit of the foregoing method includes: performing radar sensing in a directed manner based on a communication result, thereby saving a spectrum resource.

According to one aspect of this application, the foregoing method is characterized in that at least one candidate reference signal resource included in the candidate reference signal resource set is associated with a sensing signal.

In an embodiment, a problem to be resolved by this application includes: how to improve sensing precision.

In an embodiment, a characteristic of the foregoing method includes: In this application, by way of associating the sensing signal with the reference signal resource, directionality is introduced into the sensing signal, so that the system can more precisely sense information in a specific direction to resolve the foregoing problem.

In an embodiment, a characteristic of the foregoing method includes: The at least one candidate reference signal resource included in the candidate reference signal resource set is spatially associated with a sensing signal.

In an embodiment, a characteristic of the foregoing method includes: Each candidate reference signal resource included in the candidate reference signal resource set is spatially associated with a sensing signal.

In an embodiment, a characteristic of the foregoing method includes: A sender of the sensing signal can send the sensing signal in a beamforming manner.

In an embodiment, a benefit of the foregoing method includes: concentrating sensing resources to obtain information in a specific direction.

In an embodiment, a benefit of the foregoing method includes: improving system spectral efficiency and allowing a plurality of users or devices to sense and communicate in parallel.

In an embodiment, a benefit of the foregoing method includes: The system can dynamically adjust sensing and communication directions based on a current environment and need.

In an embodiment, a benefit of the foregoing method includes: reducing a possibility of being listened to or interfered with by an unauthorized direction, and improving network security.

According to one aspect of this application, the foregoing method includes: receiving a second information block, where the second information block indicates the candidate reference signal resource set.

The at least one candidate reference signal resource in the candidate reference signal resource set is associated with the first time unit set.

In an embodiment, a problem to be resolved by this application includes: how the first node determines the candidate reference signal resource set.

In an embodiment, a characteristic of the foregoing method includes: The first node in this application obtains configuration of the candidate reference signal resource set through the indication of the second information block, thereby resolving the foregoing problem.

In an embodiment, a characteristic of the foregoing method includes: The second information block is born by RRC signaling, and the first time unit set is configured per reference signal resource set.

In an embodiment, a characteristic of the foregoing method includes: The second information block is born by dynamic signaling.

In an embodiment, a benefit of the foregoing method includes: By configuring a specific time unit set for each beam, the system can dynamically adjust and optimize each beam based on a current network condition, a traffic demand, or another factor.

In an embodiment, a benefit of the foregoing method includes: Time window configuration for different beams can be adjusted based on requirements of different service levels.

In an embodiment, a benefit of the foregoing method includes: enabling a network to be more dynamic and adaptable, which helps to cope with different network environments and demands, and makes the network more scalable.

According to one aspect of this application, the foregoing method is characterized in that the first node is a base station.

According to one aspect of this application, the foregoing method is characterized in that the first node is a user equipment.

According to one aspect of this application, the foregoing method is characterized in that the first node is a serving cell.

According to one aspect of this application, the foregoing method is characterized in that the first node is a serving cell of the first node.

According to one aspect of this application, the foregoing method is characterized in that the first node is a relay node.

This application discloses a method in a second node used for reference signal transmission in wireless communication, including:
sending first signaling, where the first signaling indicates a first reference signal resource; and sending second signaling and a first reference signal, where whether the first reference signal can be jointly used with another reference signal received in the first reference signal resource for path loss calculation depends on the second signaling.

A resource element occupied by the first reference signal in a time unit in which the first reference signal is located belongs to the first reference signal resource.

According to one aspect of this application, the foregoing method includes:
sending a first information block, where the first information block indicates a first time unit set.

The time unit in which the first reference signal is located is a time unit in the first time unit set, and the first time unit set depends on a spatial relation of the first reference signal resource.

According to one aspect of this application, the foregoing method is characterized in that the second node determines the first time unit set based on a sensing signal.

According to one aspect of this application, the foregoing method is characterized in that when the second signaling indicates the time unit in which the first reference signal is located, and the spatial relation of the first reference signal resource is associated with a candidate reference signal resource set, the first reference signal cannot be jointly used with the another reference signal received in the first reference signal resource for path loss calculation.

According to one aspect of this application, the foregoing method is characterized in that the second signaling indicates a first resource element set, and a value of a symbol transmitted on a resource element in the first resource element set depends on a first waveform; and the second signaling indicates that the spatial relation of the first reference signal resource is associated with a candidate reference signal resource set, and the first reference signal cannot be jointly used with the another reference signal received in the first reference signal resource for path loss calculation.

According to one aspect of this application, the foregoing method is characterized in that at least one candidate reference signal resource included in the candidate reference signal resource set is associated with a sensing signal.

According to one aspect of this application, the foregoing method includes:
sending a second information block, where the second information block indicates the candidate reference signal resource set.

The at least one candidate reference signal resource in the candidate reference signal resource set is associated with the first time unit set.

According to one aspect of this application, the foregoing method is characterized in that the second node is a user equipment.

According to one aspect of this application, the foregoing method is characterized in that the second node is a relay node.

This application discloses a device of a first node used for reference signal transmission in wireless communication, including:
a first receiver, configured to: receive first signaling, where the first signaling indicates a first reference signal resource; and receive second signaling and a first reference signal, where whether the first reference signal can be jointly used with another reference signal received in the first reference signal resource for path loss calculation depends on the second signaling.

A resource element occupied by the first reference signal in a time unit in which the first reference signal is located belongs to the first reference signal resource.

This application discloses a device of a second node used for reference signal transmission in wireless communication, including:
a first transmitter, configured to: send first signaling, where the first signaling indicates a first reference signal resource; and send second signaling and a first reference signal, where whether the first reference signal can be jointly used with another reference signal received in the first reference signal resource for path loss calculation depends on the second signaling.

A resource element occupied by the first reference signal in a time unit in which the first reference signal is located belongs to the first reference signal resource.

In an embodiment, compared with a conventional solution, this application has the following advantages, which are beneficial but not limited to:

This application supports an ISAC technology, so that a wireless network can perform high-quality communication interaction while simultaneously implementing a high-precision, fine-grained sensing function, thereby improving system spectral efficiency, energy efficiency, and hardware efficiency and obtaining an integration gain.

This application implements sensing-assisted communication in an ISAC system, thereby improving communication performance and obtaining a coordination gain.

This application implements communication-assisted sensing in the ISAC system, thereby improving sensing efficiency and sensing performance and obtaining a coordination gain.

This application reasonably predicts time when L1-RSRP may have an outlier based on the sensing signal, thereby reducing a probability that path loss is affected by the outlier, and facilitating a correct estimating of path loss.

This application optimizes path loss calculation to reduce an increase of uplink transmission power caused by a transient beam blockage, thereby improving a terminal battery life and saving energy.

### BRIEF DESCRIPTION OF DRAWINGS

Other features, objectives, and advantages of this application become more apparent by reading detailed descriptions of non-limiting embodiments with reference to the following drawings:

FIG. 1 is a flowchart of transmission of a first node according to an embodiment of this application;

FIG. 2 is a schematic diagram of a network architecture according to an embodiment of this application;

FIG. 3 is a schematic diagram of an embodiment of radio protocol architectures for a user plane and a control plane according to an embodiment of this application;

FIG. 4 is a schematic diagram of a first communication device and a second communication device according to an embodiment of this application;

FIG. 5 is a flowchart of transmission between a first node and a second node according to an embodiment of this application;

FIG. 6 is a 1^{st} schematic diagram of a first time unit set according to an embodiment of this application;

FIG. 7 is a 2^{nd} schematic diagram of a first time unit set according to an embodiment of this application;

FIG. 8 is a schematic diagram of two ways for a second node to sense a target node according to an embodiment of this application;

FIG. 9 is a 1^{st} schematic diagram in which a first reference signal cannot be jointly used with another reference signal received in a first reference signal resource for path loss calculation according to an embodiment of this application;

FIG. 10 is a 2^{nd} schematic diagram in which a first reference signal cannot be jointly used with another reference signal received in a first reference signal resource for path loss calculation according to an embodiment of this application;

FIG. 11 is a 1^{st} schematic diagram of a candidate reference signal resource set according to an embodiment of this application;

FIG. 12 is a 2^{nd} schematic diagram of a candidate reference signal resource set according to an embodiment of this application;

FIG. 13 is a block diagram of a structure of a processing apparatus used for a first node according to an embodiment of this application; and

FIG. 14 is a block diagram of a structure of a processing apparatus used for a second node according to an embodiment of this application.

### DESCRIPTION OF EMBODIMENTS

The technical solutions of this application are further described in detail below with reference to the accompanying drawings. It should be noted that, in a case of no conflict, embodiments and features in the embodiments of this application can be arbitrarily combined with each other.

### Embodiment 1

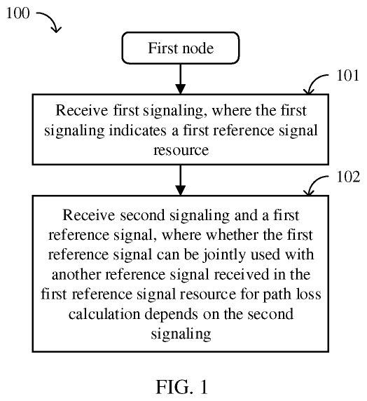

Embodiment 1 illustrates a flowchart of transmission of a first node according to an embodiment of this application, as shown in FIG. 1. In FIG. 1, each box represents a step. Specifically, an order of steps in the boxes does not represent a specific temporal sequence among the steps.

The first node receives first signaling in step 101, where the first signaling indicates a first reference signal resource; and receives second signaling and a first reference signal in step 102, where whether the first reference signal can be jointly used with another reference signal received in the first reference signal resource for path loss calculation depends on the second signaling.

In Embodiment 1, a resource element occupied by the first reference signal in a time unit in which the first reference signal is located belongs to the first reference signal resource.

In an embodiment, the first node is a first node in this application.

In an embodiment, the first node receives the first signaling.

In an embodiment, the first signaling is UE (User Equipment, user equipment)-dedicated (UE-dedicated).

In an embodiment, the first signaling is UE-specific (UE-specific).

In an embodiment, the first signaling includes higher layer (higher layer) signaling.

In an embodiment, the first signaling is higher layer signaling.

In an embodiment, the first signaling includes RRC (Radio Resource Control, radio resource control) signaling.

In an embodiment, the first signaling is RRC signaling.

In an embodiment, the first signaling includes one or more RRC IEs (Information Element, information element).

In an embodiment, the first signaling includes one or more fields (field) in an RRC IE.

In an embodiment, the first signaling includes information in all or part of fields of each RRC IE in a plurality of RRC IEs.

In an embodiment, the first signaling includes MAC (Medium Access Control, medium access control) layer signaling.

In an embodiment, the first signaling is MAC layer signaling.

In an embodiment, the first signaling includes a MAC CE (Control Element, control element).

In an embodiment, the first signaling includes RRC signaling and a MAC CE.

In an embodiment, the first signaling is jointly born by RRC signaling and a MAC CE.

In an embodiment, the first reference signal resource corresponds to a reference signal resource identifier (identification).

In an embodiment, the first reference signal resource corresponds to a reference signal resource identity (identity).

In an embodiment, the first reference signal resource corresponds to a reference signal resource index (index).

In an embodiment, the first reference signal resource includes a reference signal.

In an embodiment, the first reference signal resource includes a code domain resource.

In an embodiment, the first reference signal resource includes a spatial domain resource.

In an embodiment, the first reference signal resource includes a port (port).

In an embodiment, the port described in this application includes at least one of an antenna port (antenna port(s)), a reference signal port, a CSI-RS (Channel State Information-Reference Signal, channel state information-reference signal) port, a logical port, and a physical port.

In an embodiment, the first reference signal resource includes a time domain resource.

In an embodiment, the first reference signal resource is periodically configured.

In an embodiment, the first reference signal resource is periodic (Periodic) in time domain.

In an embodiment, the first reference signal resource is semi-persistent (Semi-Persistent, SP) in time domain.

In an embodiment, the first reference signal resource is located in a plurality of sub-frames (sub-frame) in time domain.

In an embodiment, the first reference signal resource is located in a plurality of slots (slot) in time domain.

In an embodiment, the first reference signal resource includes a plurality of sub-frames in time domain.

In an embodiment, the first reference signal resource includes a plurality of slots in time domain.

In an embodiment, the first reference signal resource includes at least one multicarrier symbol (symbol) in a slot in time domain.

In an embodiment, the first reference signal resource includes a plurality of multicarrier symbols in a slot in time domain.

In an embodiment, the multicarrier symbol in this application includes an OFDM (Orthogonal Frequency Division Multiplexing, orthogonal frequency division multiplexing) symbol.

In an embodiment, the multicarrier symbol in this application is an OFDM symbol.

In an embodiment, the multicarrier symbol in this application includes an FBMC (Filter Bank Multi Carrier, Filter Bank Multicarrier) symbol.

In an embodiment, the multicarrier symbol in this application includes a UFMC (Universal Filtered Multi Carrier, universal filtered multicarrier) symbol.

In an embodiment, the multicarrier symbol in this application includes an F-OFDM (Filtered-OFDM, filtered orthogonal frequency division multiplexing) symbol.

In an embodiment, the multicarrier symbol in this application includes an OCDM-OFDM (Orthogonal Chirp Division Multiplexing-OFDM, orthogonal chirp division multiplexing-orthogonal frequency division multiplexing) symbol.

In an embodiment, the multicarrier symbol in this application includes a CP-OFDM (Cyclic Prefix-OFDM, Cyclic Prefix-Orthogonal Frequency Division Multiplexing) symbol.

In an embodiment, the multicarrier symbol in this application is a downlink (DownLink, DL) symbol.

In an embodiment, the multicarrier symbol in this application is a flexible (Flexible, F) symbol.

In an embodiment, any multicarrier symbol in the plurality of multicarrier symbols is one of a DL symbol and a flexible symbol.

In an embodiment, the first reference signal resource includes a frequency domain resource.

In an embodiment, a frequency domain resource across (across) which the first reference signal resource passes includes at least one sub-band (sub-band).

In an embodiment, the frequency domain resource across which the first reference signal resource passes includes a set of downlink resource blocks.

In an embodiment, the frequency domain resource across which the first reference signal resource passes includes at least one resource block set (set).

In an embodiment, the frequency domain resource across which the first reference signal resource passes includes at least one resource block.

In an embodiment, the first reference signal resource includes at least one sub-band in frequency domain.

In an embodiment, the first reference signal resource includes a set of downlink resource blocks in frequency domain.

In an embodiment, the first reference signal resource includes at least one resource block set in frequency domain.

In an embodiment, the first reference signal resource includes at least one resource block in frequency domain.

In an embodiment, the resource block in this application refers to: Resource Block, RB.

In an embodiment, the resource block in this application refers to: Resource Group, RG.

In an embodiment, the resource block in this application refers to: physical (physical) resource block.

In an embodiment, the resource block in this application refers to: virtual (virtual) resource block.

In an embodiment, the resource block in this application refers to: common (common) resource block.

Typically, the resource block in this application includes 12 consecutive subcarriers (subcarrier) in frequency domain.

In an embodiment, the first reference signal resource includes a time frequency resource.

In an embodiment, the first reference signal resource occupies at least one resource element.

In an embodiment, the resource element includes a time domain resource.

In an embodiment, the resource element includes a frequency domain resource.

In an embodiment, the resource element includes a time frequency resource.

In an embodiment, the resource element occupies one multicarrier symbol in time domain and occupies one subcarrier in frequency domain.

In an embodiment, the resource element is: Resource Unit, RU.

In an embodiment, the resource element is: Resource Element, RE.

In an embodiment, the one resource element in this application is used to transmit one symbol.

In an embodiment, the one resource element in this application is used to transmit one modulation symbol (modulation symbol).

In an embodiment, the one resource element in this application is used to transmit one complex-valued symbol (complex-valued symbol).

In an embodiment, the one resource element in this application is used to transmit one complex-valued modulation symbol (complex-valued modulation symbol).

In an embodiment, the one resource element in this application corresponds to (corresponds to) one complex value (complex value).

In an embodiment, the first reference signal resource occupies a plurality of resource elements in a configured period.

In an embodiment, the first reference signal resource occupies a plurality of resource elements in a configured sub-frame.

In an embodiment, the first reference signal resource occupies a plurality of resource elements in a configured slot.

In an embodiment, the first reference signal resource occupies a plurality of resource elements in a configured multicarrier symbol.

In a sub-embodiment of this embodiment, the plurality of resource elements are consecutive in frequency domain.

In a sub-embodiment of this embodiment, at least two resource elements in the plurality of resource elements are consecutive in frequency domain.

In a sub-embodiment of this embodiment, at least two resource elements in the plurality of resource elements are non-consecutive in frequency domain.

In an embodiment, the first reference signal resource is UE-dedicated.

In an embodiment, the first reference signal resource is cell-specific (cell-specific).

In an embodiment, the first reference signal resource includes a reference signal resource used for measuring path loss in a 6G system.

In an embodiment, the first reference signal resource is one of reference signal resources used for measuring path loss in a 6G system.

In an embodiment, the first reference signal resource includes one of a CSI-RS resource and an SSB.

In an embodiment, the first reference signal resource is one of a CSI-RS resource and an SSB.

In an embodiment, the first reference signal resource includes a CSI-RS resource.

In an embodiment, the first reference signal resource is a CSI-RS resource.

In an embodiment, the first reference signal resource is an NZP (Non-Zero Power, non-zero power) CSI-RS resource.

In an embodiment, the first reference signal resource corresponds to an NZP-CSI-RS-ResourceId.

In an embodiment, the first reference signal resource includes an SSB.

In an embodiment, the first reference signal resource is an SSB.

In an embodiment, the first reference signal resource corresponds to an SSB-Index.

In an embodiment, the first reference signal resource corresponds to an ssb-Index.

In an embodiment, the SSB in this application refers to: Synchronization Signal Block, synchronization signal block.

In an embodiment, the SSB in this application refers to: SS (Synchronization Signal)/PBCH (Physical Broadcast Channel) block, synchronization signal/physical broadcast channel block.

Typically, reception occasions (occasion) of a PBCH, a PSS (Primary Synchronization Signal, primary synchronization signal), and an SSS (Secondary Synchronization Signal, secondary synchronization signal) are in consecutive multicarrier symbols and form an SS/PBCH block.

In an embodiment, the first signaling configures the first reference signal resource.

In an embodiment, the first signaling includes configuration information of the first reference signal resource.

In an embodiment, configuration information of a reference signal resource in this application includes part or all of a time domain resource, a frequency domain resource, a CDM (Code Division Multiplexing, code division multiplexing) type, a scrambling identifier (scrambling ID), a QCL (Quasi Co-Location, quasi co-location), density (density), a quantity of ports (port(s)), a cyclic shift (cycle shift), OCC (Orthogonal Cover Code, orthogonal cover code), a transmission sequence (sequence), and a TCI (Transmission Configuration Indicator, transmission configuration indicator).

In an embodiment, the first signaling includes ServingCellConfig IE.

In an embodiment, the first signaling includes one or more fields in ServingCellConfig IE.

In an embodiment, the first signaling includes CSI-MeasConfig IE.

In an embodiment, the first signaling includes one or more fields in CSI-MeasConfig IE.

In an embodiment, the first signaling includes NZP-CSI-RS-Resource IE.

In an embodiment, the first signaling includes one or more fields in NZP-CSI-RS-Resource IE.

In an embodiment, the first signaling includes CSI-RS-ResourceMapping IE.

In an embodiment, the first signaling includes one or more fields in CSI-RS-ResourceMapping IE.

In an embodiment, the first signaling includes CSI-ResourcePeriodicityAndOffset IE.

In an embodiment, the first signaling includes one or more fields in CSI-ResourcePeriodicityAndOffset IE.

In an embodiment, the first signaling includes NZP-CSI-RS-ResourceSet IE.

In an embodiment, the first signaling includes one or more fields in NZP-CSI-RS-ResourceSet IE.

In an embodiment, the first signaling includes CSI-IM-Resource IE.

In an embodiment, the first signaling includes one or more fields in CSI-IM-Resource IE.

In an embodiment, the first signaling includes CSI-IM-ResourceSet IE.

In an embodiment, the first signaling includes one or more fields in CSI-IM-ResourceSet IE.

In an embodiment, the first signaling includes CSI-ResourceConfig IE.

In an embodiment, the first signaling includes one or more fields in CSI-ResourceConfig IE.

In an embodiment, the first signaling includes CSI-SSB-ResourceSet IE.

In an embodiment, the first signaling includes one or more fields in CSI-SSB-ResourceSet IE.

In an embodiment, the first signaling includes ServingCellConfigCommon IE.

In an embodiment, the first signaling includes one or more fields in ServingCellConfigCommon IE.

In an embodiment, the first signaling includes ServingCellConfigCommonSIB IE.

In an embodiment, the first signaling includes one or more fields in ServingCellConfigCommonSIB IE.

In an embodiment, the first signaling includes an ssb-PositionsInBurst field.

In an embodiment, the first signaling includes an ssb-periodicityServingCell field.

In an embodiment, the first signaling indicates the first reference signal resource.

In an embodiment, the first signaling includes BWP-UplinkDedicated IE.

In an embodiment, the first signaling includes one or more fields in BWP-UplinkDedicated IE.

In an embodiment, the first signaling includes PUCCH-PowerControl IE.

In an embodiment, the first signaling includes one or more fields in PUCCH-PowerControl IE.

In an embodiment, the first signaling includes PUCCH-SpatialRelationInfo IE.

In an embodiment, the first signaling includes one or more fields in PUCCH-SpatialRelationInfo IE.

In an embodiment, the first signaling includes PUSCH-PowerControl IE.

In an embodiment, the first signaling includes one or more fields in PUSCH-PowerControl IE.

In an embodiment, the first signaling includes SRS-Config IE.

In an embodiment, the first signaling includes one or more fields in SRS-Config IE.

In an embodiment, the first signaling includes SRS-ResourceSet IE.

In an embodiment, the first signaling includes one or more fields in SRS-ResourceSet IE.

In an embodiment, the first signaling includes ConfiguredGrantConfig IE.

In an embodiment, the first signaling includes one or more fields in ConfiguredGrantConfig IE.

In an embodiment, the first signaling includes TCI-UL-State IE.

In an embodiment, the first signaling includes one or more fields in TCI-UL-State IE.

In an embodiment, the first signaling includes PathlossReferenceRS IE.

In an embodiment, the first signaling includes one or more fields in PathlossReferenceRS IE.

In an embodiment, the first signaling includes SP CSI-RS/CSI-IM Resource Set Activation/Deactivation MAC CE.

In an embodiment, the first signaling includes SP ZP CSI-RS Resource Set Activation/Deactivation MAC CE.

In an embodiment, the first signaling includes SP CSI reporting on PUCCH Activation/Deactivation MAC CE.

In an embodiment, the first node receives the second signaling.

In an embodiment, the second signaling is broadcast (broadcast).

In an embodiment, the second signaling is multicast (multicast).

In an embodiment, the second signaling includes dynamic signaling.

In an embodiment, the second signaling is dynamic signaling.

In an embodiment, the second signaling includes MAC layer signaling.

In an embodiment, the second signaling is a MAC CE.

In an embodiment, the second signaling includes physical layer signaling.

In an embodiment, the second signaling is physical layer signaling.

In an embodiment, the second signaling is L1 (Layer-1, layer-1) signaling.

In an embodiment, the second signaling is DCI (Downlink Control Information, downlink control information).

In an embodiment, the second signaling is DCI, and CRC (Cyclic Redundancy Check, cyclic redundancy check) of the second signaling is scrambled by an RNTI other than a C (Cell)-RNTI (Radio Network Temporary Identifier, radio network temporary identifier).

In an embodiment, the first node receives the first reference signal.

In an embodiment, the first node receives the first reference signal in the first reference signal resource.

In an embodiment, the first node receives the first reference signal based on configuration of the first reference signal resource.

In an embodiment, the first reference signal includes a reference signal used for measuring path loss in a 6G system.

In an embodiment, the first reference signal is one of reference signals used for measuring path loss in a 6G system.

In an embodiment, the first reference signal is one of a CSI-RS and an SSB.

In an embodiment, the first reference signal includes a CSI-RS.

In an embodiment, the first reference signal is a CSI-RS.

In an embodiment, the first reference signal includes an SSB.

In an embodiment, the first reference signal is an SSB.

In an embodiment, whether the first RS can be jointly used with the another RS received in the first RS resource for PL calculation depends on the second signaling.

In an embodiment, the another reference signal received in the first reference signal resource includes a reference signal whose occupied time domain resource belongs to the first reference signal resource and whose occupied time domain resource is orthogonal to the first reference signal.

In an embodiment, the another reference signal received in the first reference signal resource includes a reference signal whose occupied time frequency resource belongs to the first reference signal resource and whose occupied time frequency resource is orthogonal to the first reference signal.

In an embodiment, the another reference signal received in the first reference signal resource includes a reference signal that is other than the first reference signal and that is determined by the configuration information of the first reference signal resource.

In an embodiment, the another reference signal received in the first reference signal resource includes a reference signal that is other than the first reference signal and that is indicated by the configuration information of the first reference signal resource.

In an embodiment, the another reference signal received in the first reference signal resource includes a reference signal that is other than the first reference signal and that is transmitted based on the configuration information of the first reference signal resource.

In an embodiment, the another reference signal received in the first reference signal resource includes: a candidate time unit set is configured for the first reference signal resource, and the another reference signal is, in the candidate time unit set, a reference signal associated with the first reference signal resource in at least one time unit outside the time unit in which the first reference signal is located.

In an embodiment, the second signaling indicates whether the first reference signal can be jointly used with the another reference signal received in the first reference signal resource for path loss calculation.

In an embodiment, the second signaling is used to determine whether the first reference signal can be jointly used with the another reference signal received in the first reference signal resource for path loss calculation.

In an embodiment, the second signaling indicates a time domain resource that is occupied by a reference signal received in the first reference signal resource and that cannot be jointly used with the another signal received in the first reference signal resource for path loss calculation.

In an embodiment, the second signaling indicates a reference signal resource that is associated with a spatial relation of a reference signal received in the first reference signal resource and that cannot be jointly used with the another signal received in the first reference signal resource for path loss calculation.

In an embodiment, when the first reference signal can be jointly used with the another reference signal received in the first reference signal resource for path loss calculation, RSRP determined by measuring the first reference signal cannot be jointly used with RSRP obtained by measuring the another reference signal for path loss calculation.

In an embodiment, when the first reference signal can be jointly used with the another reference signal received in the first reference signal resource for path loss calculation, RSRP obtained through linear averaging of RSRP determined by measuring the first reference signal and RSRP obtained by measuring the another reference signal is used for path loss calculation.

In an embodiment, when the first reference signal can be jointly used with the another reference signal received in the first reference signal resource for path loss calculation, RSRP obtained after the RSRP determined by measuring the first reference signal and the RSRP obtained by measuring the another reference signal are processed through a layer-3 (Layer-3, L3) filter is used for path loss calculation.

In an embodiment, when the first reference signal can be jointly used with the another reference signal received in the first reference signal resource for path loss calculation, RSRP obtained through sliding filter of the RSRP determined by measuring the first reference signal and the RSRP obtained by measuring the another reference signal is used for path loss calculation.

In an embodiment, when the first reference signal can be jointly used with the another reference signal received in the first reference signal resource for path loss calculation, the first node, in an implementation-related manner, uses RSRP determined by measuring the first reference signal and RSRP obtained by measuring the another reference signal for path loss calculation.

In a sub-embodiment of the foregoing five embodiments, the RSRP determined by measuring the first reference signal refers to: L1-RSRP.

In a sub-embodiment of the foregoing five embodiments, the RSRP determined by measuring the first reference signal refers to: SS-RSRP.

In a sub-embodiment of the foregoing five embodiments, the RSRP determined by measuring the first reference signal refers to: CSI-RSRP.

In an embodiment, a resource occupied by the first reference signal belongs to the first reference signal resource.

In an embodiment, the first reference signal resource includes the resource occupied by the first reference signal.

In an embodiment, the first reference signal is single transmission of the first reference signal resource.

In an embodiment, the first reference signal is transmitted once based on the configuration information of the first reference signal resource.

In an embodiment, a meaning of the time unit in which the first reference signal is located includes: a time unit occupied by the first reference signal.

In an embodiment, a meaning of the time unit in which the first reference signal is located includes: A time domain resource occupied by the first reference signal belongs to the time unit in which the first reference signal is located.

In an embodiment, a meaning of the time unit in which the first reference signal is located includes: A transmission occasion of the first reference signal belongs to the time unit in which the first reference signal is located.

In an embodiment, a meaning of the time unit in which the first reference signal is located includes: The time unit in which the first reference signal is located includes at least one multicarrier symbol, and the first reference signal occupies one multicarrier symbol in the at least one multicarrier symbol.

In an embodiment, a meaning of the time unit in which the first reference signal is located includes: The time unit in which the first reference signal is located includes at least one multicarrier symbol not occupied by the first reference signal.

In an embodiment, the first reference signal is a reference signal in a resource element configured for the first reference signal resource of the first reference signal resource in a time unit indicated by the second signaling.

In an embodiment, the first reference signal is a reference signal in a resource element configured for the first reference signal resource of the first reference signal resource in a time unit corresponding to the second signaling.

In an embodiment, the time unit is a slot.

In an embodiment, the time unit is a sub-frame.

In an embodiment, a time unit described in this application is a time resource including M1 consecutive multicarrier symbols, where M1 is a positive integer greater than 1.

In a sub-embodiment of the foregoing embodiment, a value of M1 is fixed.

In a sub-embodiment of the foregoing embodiment, a value of M1 is configurable.

In a sub-embodiment of the foregoing embodiment, a value of M1 depends on a subcarrier spacing (SubCarrier Spacing, SCS).

In a sub-embodiment of the foregoing embodiment, a value of M1 depends on an operation band (operation band) occupied by the first reference signal resource.

Embodiment 2

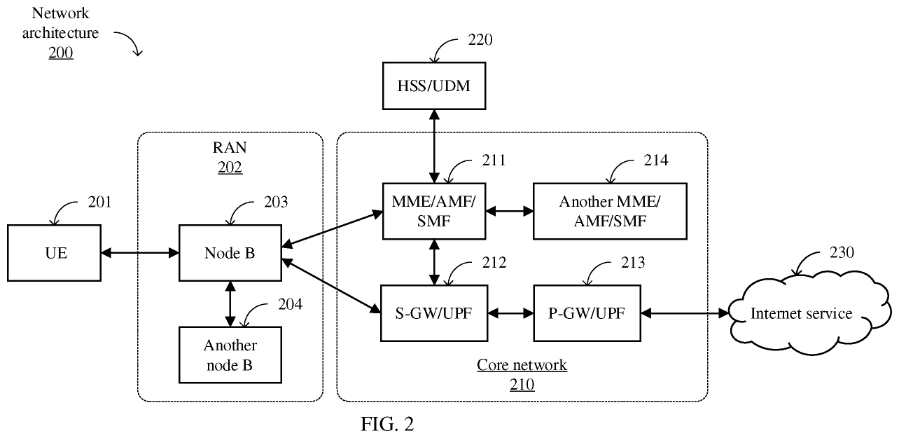

Embodiment 2 illustrates a schematic diagram of a network architecture according to an embodiment of this application, as shown in FIG. 2.

FIG. 2 describes a network architecture 200. The network architecture 200 is a network architecture of LTE (Long-Term Evolution, long term evolution), LTE-A (Long-Term Evolution Advanced, long term evolution advanced), a 5G system, 5G-Advanced, and a future 6G system. The network architecture of the LTE, the LTE-A, the 5G system, 5G-Advanced, and the future 6G system is referred to as an EPS (Evolved Packet System, evolved packet system). A 5G NR or LTE network architecture may be referred to as a 5GS (5G System)/EPS or some other suitable terminology; a 6G network architecture may be referred to as a 6GS (6G System)/EPS or some other suitable terminology. The network architecture 200 may include one or more UEs 201, a RAN (Next Generation Radio Access Network, next generation radio access network) 202, a core network 210, an HSS (Home Subscriber Server, home subscriber server)/UDM (Unified Data Management, unified data management) 220, and an internet service 230. The network architecture 200 can be interconnected with another access network, but these entities/interfaces are not shown for simplicity. As shown in FIG. 2, the network architecture 200 provides a packet switching service. However, a person skilled in the art will readily understand that the various concepts presented throughout this application can be extended to a network providing a circuit switching service. The RAN 202 includes a node B 203 and another node 204. The node 203 provides user and control plane protocol termination towards the UE 201. The node 203 may be connected to the another node 204 through an Xn interface (for example, backhaul). The node 203 may also be referred to as a base station, a base transceiver station, a radio base station, a radio transceiver, a transceiver function, a basic service set (Basic Service Set, BSS), an extended service set (Extended Service Set, ESS), a TRP (Transmitter Receiver Point, transmission reception point), or some other suitable terminology. The node 203 provides an access point to the core network 210 for the UE 201, and the core network 210 is a 5GC (5G Core Network, 5G core network)/EPC (Evolved Packet Core, evolved packet core), or the core network 210 is a 6GC. Instances of the UE 201 include a cellular phone, a smart phone, a session initiation protocol (Session Initiation Protocol, SIP) phone, a laptop computer, a personal digital assistant (Personal Digital Assistant, PDA), satellite radio, a global positioning system, a multimedia apparatus, a video apparatus, a digital audio player (for example, an MP3 player), a camera, a game console, a drone, a flying machine, a narrowband physical network device, a machine type communication device, a land vehicle, an automobile, a wearable device, or any other similar functional apparatus. A person skilled in the art may also refer to the UE 201 as a mobile station, a subscriber station, a mobile unit, a subscriber unit, a wireless unit, a remote unit, a mobile apparatus, a wireless apparatus, a wireless communication apparatus, a remote apparatus, a mobile subscriber station, an access terminal, a mobile terminal, a wireless terminal, a remote terminal, a handset, a user agent, a mobile client, a client, or some other suitable terminology. The node 203 is connected to the core network 210 through an S1/NG interface. The core network 210 includes an MME (Mobility Management Entity, mobility management entity)/AMF (Authentication Management Field, authentication management field)/SMF (Session Management Function, session management function) 211, another MME/AMF/SMF 214, an S-GW (Service Gateway, service gateway)/UPF (User Plane Function, user plane function) 212, and a P-GW (Packet Date Network Gateway, packet data network gateway)/UPF 213. The MME/AMF/SMF 211 is a control node that processes signaling between the UE 201 and the 5G-CN/EPC 210. Generally, the MME/AMF/SMF 211 provides bearer and connection management. All user IP (Internet Protocol, internet protocol) packets are transmitted through the S-GW/UPF 212, and the S-GW/UPF 212 itself is connected to the P-GW/UPF 213. The P-GW provides UE IP address allocation and another function. The P-GW/UPF 213 is connected to the internet service 230. The internet service 230 includes an operator-corresponding internet protocol service, which may specifically include an internet, an intranet, an IMS (IP Multimedia Subsystem, IP multimedia subsystem), and a packet switching (packet switching) service.

In an embodiment, a first node in this application includes the UE 201.

In an embodiment, a second node in this application includes the node 203.

In an embodiment, the second node in this application includes the node 204.

In an embodiment, the node 203 is a macro cell (Marco Cell) base station.

In an embodiment, the node 203 is a micro cell (Micro Cell) base station.

In an embodiment, the node 203 is a pico cell (Pico Cell) base station.

In an embodiment, the node 203 is a femtocell (Femtocell).

In an embodiment, the node 203 is a base station device that supports large delay spread.

In an embodiment, the node 203 is a flying platform device.

In an embodiment, the node 203 is a satellite device.

In an embodiment, the node 203 is a test device (for example, a transceiver apparatus that simulates some functions of a base station, or a signaling tester).

In an embodiment, the node 204 is a macro cell base station.

In an embodiment, the node 204 is a micro cell base station.

In an embodiment, the node 204 is a pico cell base station.

In an embodiment, the node 204 is a femtocell.

In an embodiment, the node 204 is a base station device that supports large delay spread.

In an embodiment, the node 204 is a flying platform device.

In an embodiment, the node 204 is a satellite device.

In an embodiment, the node 204 is a test device (for example, a transceiver apparatus that simulates some functions of a base station, or a signaling tester).

In an embodiment, the node 204 is a relay node device.

In an embodiment, the node 203 and the node 204 are a same node.

In an embodiment, the node 203 and the node 204 are two different nodes.

In an embodiment, the UE 201 is a mobile phone.

In an embodiment, the UE 201 is a vehicle including an automobile.

In an embodiment, a radio link from the UE 201 to the node 203 is an uplink, and the uplink is used to perform uplink transmission.

In an embodiment, a radio link from the node 203 to the UE 201 is a downlink, and the downlink is used to perform downlink transmission.

In an embodiment, a radio link between the node 203 and the UE 201 includes a cellular network link.

In an embodiment, the node 203 and the UE 201 are connected through a Uu air interface.

In an embodiment, a sender of first signaling includes the node 203.

In an embodiment, a recipient of the first signaling includes the UE 201.

In an embodiment, a sender of second signaling includes the node 203.

In an embodiment, a recipient of the second signaling includes the UE 201.

In an embodiment, a sender of a first reference signal includes the node 203.

In an embodiment, a recipient of the first reference signal includes the UE 201.

In an embodiment, a sender of a first information block in this application includes the node 203.

In an embodiment, a recipient of the first information block in this application includes the UE 201.

In an embodiment, a sender of a second information block in this application includes the node 203.

In an embodiment, a recipient of the second information block in this application includes the UE 201.

In an embodiment, the node 203 supports ISAC.

In an embodiment, the UE 201 supports ISAC.

In an embodiment, the node 203 at least supports a TRP monostatic (monostatic) sensing model.

In an embodiment, the UE 201 at least supports a UE monostatic sensing model.

In an embodiment, the node 203 at least supports a TRP-UE bistatic (bistatic) sensing model.

In an embodiment, the UE 201 at least supports a TRP-UE bistatic sensing model.

In an embodiment, the node 203 at least supports a UE-TRP bistatic sensing model.

In an embodiment, the UE 201 at least supports a UE-TRP bistatic sensing model.

In an embodiment, the node 203 at least supports a TRP-TRP bistatic sensing model.

In an embodiment, the UE 201 at least supports a UE-UE bistatic sensing model.

In an embodiment, the UE 201 supports a 5G system.

In an embodiment, the node 203 supports a 5G system.

In an embodiment, the UE 201 at least supports a 6G system.

In an embodiment, the node 203 at least supports a 6G system.

### Embodiment 3

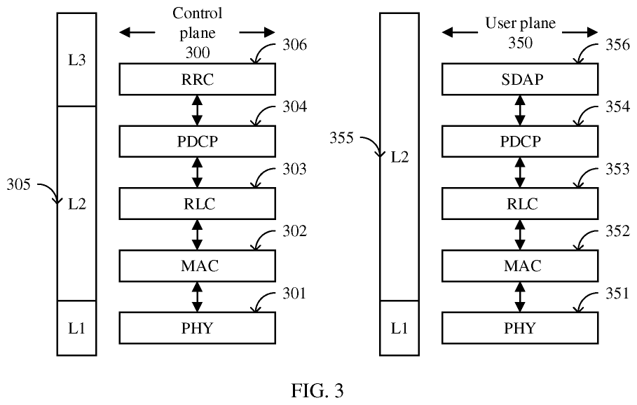

Embodiment 3 illustrates a schematic diagram of an embodiment of radio protocol architectures for a user plane and a control plane according to this application, as shown in FIG. 3.

FIG. 3 is a schematic diagram describing the embodiment of the radio protocol architectures for the user plane 350 and the control plane 300, and FIG. 3 shows, with three layers of a layer 1 (Layer 1, L1), a layer 2 (Layer 2, L2), and a layer 3 (Layer 3, L3), a radio protocol architecture of the control plane 300 between a first communication node device (a UE or an RSU (Road Side Unit, road side unit) in V2X (Vehicle to Everything, vehicle to everything), or a vehicle-mounted device or a vehicle-mounted communication module) and a second node device (a gNB, a UE or an RSU in V2X, or a vehicle-mounted device or a vehicle-mounted communication module), or between two UEs. The L1 is a lowest layer and implements various PHY (PHYsical layer) signal processing functions. The L1 is referred to as a PHY 301 in this application. The L2 305 is above the PHY 301 and is responsible for a link between the first node device and the second node device or between the two UEs through the PHY 301. The L2 layer 305 includes a MAC (Medium Access Control, medium access control) sublayer 302, an RLC (Radio Link Control, radio link control protocol) sublayer 303, and a PDCP (Packet Data Convergence Protocol, packet data convergence protocol) sublayer 304. These sublayers terminate at the second node device. The PDCP sublayer 304 provides multiplexing between different radio bearers and logical channels. The PDCP sublayer 304 also provides security by encrypting a data packet, and provides inter-cell support for the first communication node device between second communication node devices. The RLC sublayer 303 provides segmentation and reassembly of an upper layer data packet, retransmission of a lost packet, and reordering of packets to compensate for out-of-order receiving due to a HARQ (Hybrid Automatic Repeat request, hybrid automatic repeat request). The MAC sublayer 302 provides multiplexing between logical and transmission channels. The MAC sublayer 302 is also responsible for allocating various radio resources (for example, a resource block) in a cell between first node communication devices. The MAC sublayer 302 is also responsible for a HARQ operation. An RRC (Radio Resource Control, radio resource control) sublayer 306 at the L3 in the control plane 300 is responsible for obtaining a radio resource (namely, a radio bearer) and configuring a lower layer using RRC signaling between the second communication node device and the first communication node device. A radio protocol architecture for the user plane 350 includes a layer 1 (L1 layer) and a layer 2 (L2 layer). In the user plane 350, the radio protocol architecture for the first communication node device and the second communication node device is substantially the same as corresponding layers and sublayers in the control plane 300 for a physical layer 351, a PDCP sublayer 354 at the L2 355, an RLC sublayer 353 at the L2 355, and a MAC sublayer 352 at the L2 layer 355, but the PDCP sublayer 354 also provides header compression for an upper layer data packet to reduce radio transmission overheads. The L2 355 in the user plane 350 also includes an SDAP (Service Data Adaptation Protocol, service data adaptation protocol) sublayer 356, and the SDAP sublayer 356 is responsible for mapping between a QoS (Quality of Service, quality of service) flow and a data radio bearer (Data Radio Bearer, D resource block) to support service diversity. Although not shown in the figure, the first communication node device may have several upper layers above the L2 355, including a network layer (for example, an IP (Internet Protocol, internet protocol) layer) terminated at a P-GW on a network side and an application layer terminated at the other end of connection (for example, a remote UE and a server).

In an embodiment, the radio protocol architecture in FIG. 3 is applicable to a first node in this application.

In an embodiment, the radio protocol architecture in FIG. 3 is applicable to a second node in this application.

In an embodiment, first signaling is generated at the RRC 306.

In an embodiment, the first signaling is generated at the MAC 302 or MAC 352.

In an embodiment, second signaling is generated at the MAC 302 or MAC 352.

In an embodiment, the second signaling is generated at the PHY 301 or PHY 351.

In an embodiment, first information block in this application is generated at the RRC 306.

In an embodiment, the first information block in this application is generated at the PHY 301 or the PHY 351.

In an embodiment, second information block in this application is generated at the RRC 306.

In an embodiment, the second information block in this application is generated at the MAC 302 or the MAC 352.

In an embodiment, a higher layer in this application includes a layer above the physical layer.

In an embodiment, the higher layer in this application includes a MAC layer.

In an embodiment, the higher layer in this application includes an RRC layer.

### Embodiment 4

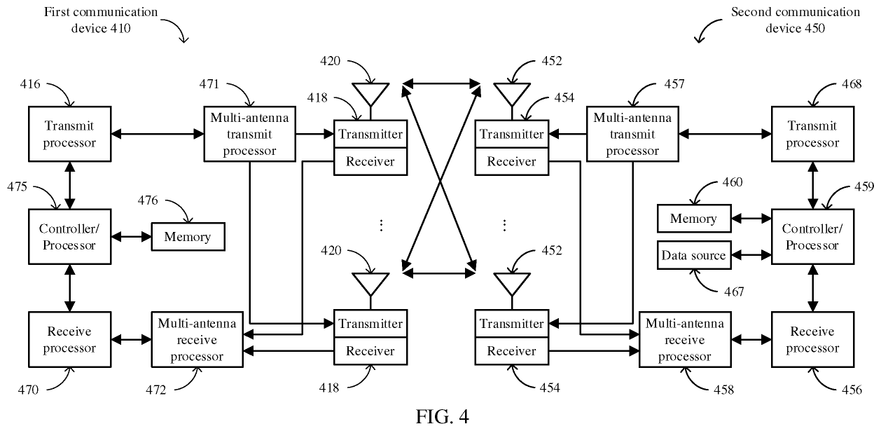

Embodiment 4 illustrates a schematic diagram of a first communication device and a second communication device according to this application, as shown in FIG. 4. Specifically, FIG. 4 is a block diagram of the first communication device 410 and the second communication device 450 communicating with each other in an access network.

The first communication device 410 includes a controller/processor 475, a memory 476, a receive processor 470, a transmit processor 416, a multi-antenna receive processor 472, a multi-antenna transmit processor 471, a transmitter/receiver 418, and an antenna 420.

The second communication device 450 includes a controller/processor 459, a memory 460, a data source 467, a transmit processor 468, a receive processor 456, a multi-antenna transmit processor 457, a multi-antenna receive processor 458, a transmitter/receiver 454, and an antenna 452.

During transmission from the first communication device 410 to the second communication device 450, at the first communication device 410, an upper layer data packet from a core network is provided for the controller/processor 475. The controller/processor 475 implements a function of an L2. In a DL, the controller/processor 475 provides header compression, encryption, packet segmentation and reordering, multiplexing between logical and transport channels, and radio resource allocation for the second communication device 450 based on various priority metrics. The controller/processor 475 is further responsible for a HARQ operation, retransmission of a lost packet, and signaling to the second communication device 450. The transmit processor 416 and the multi-antenna transmit processor 471 implement various signal processing functions of an L1 (namely, a physical layer). The transmit processor 416 implements encoding and interleaving to facilitate forward error correction (Forward Error Correction, FEC) at the second communication device 450, and mapping of signal clusters based on various modulation schemes (for example, binary phase shift keying (Binary Phase Shift Keying, BPSK), quadrature phase shift keying (Quadrature Phase Shift Keying, QPSK), M-ary phase shift keying (M-PSK), M-ary quadrature amplitude modulation (M-Quadrature Amplitude Modulation, M-QAM)). The multi-antenna transmit processor 471 performs digital space precoding, including codebook-based precoding and non-codebook-based precoding, on an encoded and modulated symbol, and beamforming processing, to generate one or more parallel streams. The transmit processor 416 then maps each parallel stream to a subcarrier, multiplexes the modulated symbol with a reference signal (for example, a pilot) in time domain and/or frequency domain, and then uses inverse fast Fourier transform (Inverse Fast Fourier Transform, IFFT) to generate a physical channel carrying a time domain multicarrier symbol stream. Subsequently, the multi-antenna transmit processor 471 performs an operation of analog precoding sending/beamforming on the time domain multicarrier symbol stream. Each transmitter 418 converts a baseband multicarrier symbol stream provided by the multi-antenna transmit processor 471 into a radio frequency stream, and then provides the radio frequency stream for different antennas 420.

During transmission from the first communication device 410 to the second communication device 450, at the second communication device 450, each receiver 454 receives a signal through a corresponding antenna 452 of the receiver 454. Each receiver 454 recovers information modulated onto a radio frequency carrier, converts a radio frequency stream into a baseband multicarrier symbol stream, and provides the baseband multicarrier symbol stream for the receive processor 456. The receive processor 456 and the multi-antenna receive processor 458 implement various signal processing functions of the L1. The multi-antenna receive processor 458 performs an operation of analog precoding receiving/beamforming on the baseband multicarrier symbol stream from the receiver 454. The receive processor 456 converts, from time domain to frequency domain through fast Fourier transform (Fast Fourier Transform, FFT), the baseband multicarrier symbol stream obtained after the operation of analog precoding receiving/beamforming. In frequency domain, a physical-layer data signal and a reference signal are demultiplexed by the receive processor 456. The reference signal is used for channel estimation; and the data signal is recovered after multi-antenna detection performed by the multi-antenna receive processor 458, to obtain any parallel stream that uses the second communication device 450 as a destination. A symbol on each parallel stream is demodulated and recovered in the receive processor 456, and a soft decision is generated. The receive processor 456 then decodes and de-interleaves the soft decision to recover upper layer data and a control signal transmitted by the first communication device 410 on a physical channel. The upper layer data and the control signal are then provided for the controller/processor 459. The controller/processor 459 implements functions of the L2. The controller/processor 459 may be associated with the memory 460 that stores program code and data. The memory 460 may be referred to as a computer-readable medium. In a DL, the controller/processor 459 provides demultiplexing between transmission and logical channels, packet reassembly, decryption, header decompression, and control signal processing, to recover the upper layer data packet from the core network. The upper layer data packet is then provided for all protocol layers above the L2, or various control signals may be provided for an L3 for processing by the L3. The controller/processor 459 is also responsible for error detection using an acknowledgement (ACKnowledgement, ACK) and/or negative acknowledgement (Negative ACKnowledgement, NACK) protocol to support a HARQ operation.

During transmission from the second communication device 450 to the first communication device 410, at the second communication device 450, an upper layer data packet is provided for the controller/processor 459 by using the data source 467. The data source 467 represents all protocol layers above the L2. Similar to the described sending function at the first communication device 410 in the DL, the controller/processor 459 implements header compression, encryption, packet segmentation and reordering, and multiplexing between logical and transmission channels based on radio resource allocation based on the first communication device 410, to implement an L2 function for a user plane and a control plane. The controller/processor 459 is also responsible for a HARQ operation, retransmission of a lost packet, and signaling to the first communication device 410. The transmit processor 468 performs modulation mapping and channel encoding processing, and the multi-antenna transmit processor 457 performs digital multi-antenna spatial precoding, including codebook-based precoding and non-codebook-based precoding, and beam forming processing. Then the transmit processor 468 modulates a generated parallel stream into a multicarrier/single-carrier symbol stream, and the multicarrier/single-carrier symbol stream is provided for different antennas 452 by using the transmitter 454 after undergoing an analog precoding/beamforming operation in the multi-antenna transmit processor 457. Each transmitter 454 first converts a baseband symbol stream provided by the multi-antenna transmit processor 457 into a radio frequency symbol stream, and then provides the radio frequency symbol stream for the antenna 452.

During transmission from the second communication device 450 to the first communication device 410, a function at the first communication device 410 is similar to the receiving function at the second communication device 450 described during the transmission from the first communication device 410 to the second communication device 450. Each receiver 418 receives a radio frequency signal through a corresponding antenna 420 of the receiver 418, converts the received radio frequency signal into a baseband signal, and provides the baseband signal for the multi-antenna receive processor 472 and the receive processor 470. The receive processor 470 and the multi-antenna receive processor 472 jointly implement the function of the L1. The controller/processor 475 implements the function of the L2. The controller/processor 475 may be associated with the memory 476 that stores program code and data. The memory 476 may be referred to as a computer-readable medium. The controller/processor 475 provides demultiplexing between transmission and logical channels, packet reassembly, decryption, header decompression, and control signal processing, to recover an upper layer data packet from the second communication device 450. An upper layer data packet from the controller/processor 475 may be provided for the core network. The controller/processor 475 is also responsible for error detection using ACK and/or NACK protocols to support a HARQ operation.

In an embodiment, the second communication device 450 apparatus includes at least one processor and at least one memory. The at least one memory includes computer program code, and the at least one memory and the computer program code are configured to be used with the at least one processor. The second communication device 450 apparatus at least receives first signaling, where the first signaling indicates a first reference signal resource; and receives second signaling and a first reference signal, where whether the first reference signal can be jointly used with another reference signal received in the first reference signal resource for path loss calculation depends on the second signaling. A resource element occupied by the first reference signal in a time unit in which the first reference signal is located belongs to the first reference signal resource.

In an embodiment, the second communication device 450 includes a memory storing a computer-readable instruction program. The computer-readable instruction program, when executed by at least one processor, generates actions, and the actions include: receiving the first signaling; and receiving the second signaling and the first reference signal.

In an embodiment, the first communication device 410 includes at least one processor and at least one memory. The at least one memory includes computer program code, and the at least one memory and the computer program code are configured to be used with the at least one processor. The first communication device 410 apparatus at least sends the first signaling, where the first signaling indicates the first reference signal resource; and sends the second signaling and the first reference signal, where whether the first reference signal can be jointly used with the another reference signal received in the first reference signal resource for path loss calculation depends on the second signaling. The resource element occupied by the first reference signal in the time unit in which the first reference signal is located belongs to the first reference signal resource.

In an embodiment, the first communication device 410 includes a memory storing a computer-readable instruction program. The computer-readable instruction program, when executed by at least one processor, generates actions, and the actions include: sending the first signaling; and sending the second signaling and the first reference signal.

In an embodiment, a first node in this application includes the second communication device 450.

In an embodiment, a second node in this application includes the first communication device 410.

In an embodiment, at least one of the antenna 420, the transmitter 418, the transmit processor 416, the multi-antenna transmit processor 471, the controller/processor 475, and the memory 476 is used to send the first signaling; and at least one of the antenna 452, the receiver 454, the receive processor 456, the multi-antenna receive processor 458, the controller/processor 459, the memory 460, and the data source 467 is used to receive the first signaling.

In an embodiment, at least one of the antenna 420, the transmitter 418, the transmit processor 416, the multi-antenna transmit processor 471, the controller/processor 475, and the memory 476 is used to send the second signaling; and at least one of the antenna 452, the receiver 454, the receive processor 456, the multi-antenna receive processor 458, the controller/processor 459, the memory 460, and the data source 467 is used to receive the second signaling.

In an embodiment, at least one of the antenna 420, the transmitter 418, the transmit processor 416, the multi-antenna transmit processor 471, the controller/processor 475, and the memory 476 is used to send the first reference signal; and at least one of the antenna 452, the receiver 454, the receive processor 456, the multi-antenna receive processor 458, the controller/processor 459, the memory 460, and the data source 467 is used to receive the first reference signal.

In an embodiment, at least one of the antenna 420, the transmitter 418, the transmit processor 416, the multi-antenna transmit processor 471, the controller/processor 475, and the memory 476 is used to send a first information block in this application; and at least one of the antenna 452, the receiver 454, the receive processor 456, the multi-antenna receive processor 458, the controller/processor 459, the memory 460, and the data source 467 is used to receive the first information block in this application.

In an embodiment, at least one of the antenna 420, the transmitter 418, the transmit processor 416, the multi-antenna transmit processor 471, the controller/processor 475, and the memory 476 is used to send a second information block in this application; and at least one of the antenna 452, the receiver 454, the receive processor 456, the multi-antenna receive processor 458, the controller/processor 459, the memory 460, and the data source 467 is used to receive the second information block in this application.

### Embodiment 5

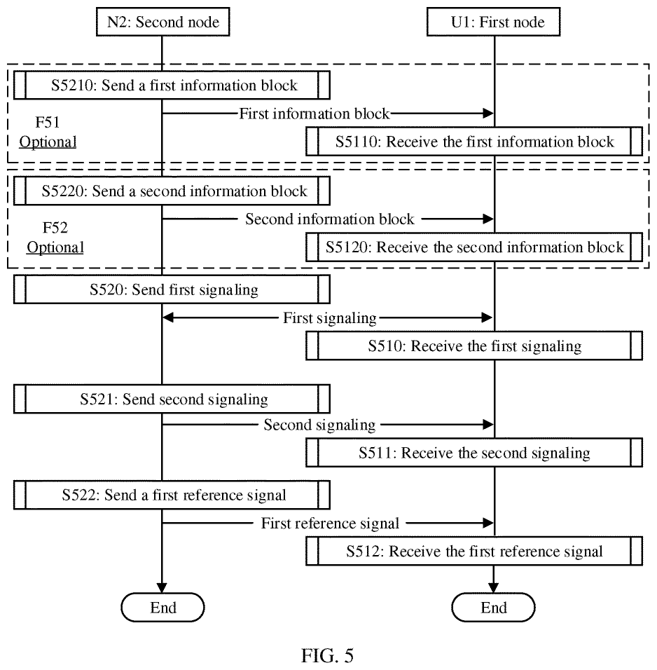

Embodiment 5 illustrates a flowchart of transmission between a first node and a second node according to an embodiment of this application. In FIG. 5, a first node U1 and a second node N2 communicate through a radio link, and steps in a box F51 and a box F52 are optional. It should be particularly noted that an order in this embodiment does not limit an order of signal transmission and an order of implementation in this application.

For the first node U1, a first information block is received in step S5110; a second information block is received in step S5120; first signaling is received in step S510; second signaling is received in step S511; and a first reference signal is received in step S512.

For the second node N2, the first information block is sent in step S5210; the second information block is sent in step S5220; the first signaling is sent in step S520; the second signaling is sent in step S521; and the first reference signal is sent in step S522.

In Embodiment 5, the first signaling indicates a first reference signal resource; whether the first reference signal can be jointly used with another reference signal received in the first reference signal resource for path loss calculation depends on the second signaling; and a resource element occupied by the first reference signal in a time unit in which the first reference signal is located belongs to the first reference signal resource.

In an embodiment, the first node U1 is the first node in this application.

In an embodiment, the second node N2 is the second node in this application.

In an embodiment, an air interface between the second node N2 and the first node U1 includes a wireless interface between a base station device and a user equipment.

In an embodiment, an air interface between the second node N2 and the first node U1 includes a wireless interface between a relay node device and a user equipment.

In an embodiment, an air interface between the second node N2 and the first node U1 includes a wireless interface between a user equipment and a user equipment.

In an embodiment, the first node N2 and the second node U1 communicate through a Uu interface.

In an embodiment, the first node U1 and the second node N2 communicate through a PC5 interface.

In an embodiment, the second node N2 is a maintenance base station of a serving cell of the first node U1.

In an embodiment, the first signaling is transmitted on a physical layer data channel (used for transmitting user data and higher layer signaling).

In an embodiment, a physical layer channel occupied by the first signaling is a PDSCH (Physical Downlink Control Channel, physical downlink control channel).

In an embodiment, a physical layer channel occupied by the first signaling is a PSCCH (Physical Sidelink Control Channel, physical sidelink control channel).

In an embodiment, a transmission channel occupied by the first signaling includes a DL-SCH (DownLink-Shared Channel, downlink shared channel).

In an embodiment, the second signaling is transmitted on a physical layer control channel (only used for transmitting a physical layer control channel).

In an embodiment, a physical layer channel occupied by the second signaling includes a PDCCH (Physical Downlink Shared Channel, physical downlink control channel).

In an embodiment, step S511 is after step S510; and step S521 is after step S520.

In an embodiment, step S512 is after step S511; and step S522 is after step S521.

In an embodiment, the steps in the box F51 in FIG. 5 exist; the method applied to the first node U1 in this application includes: receiving the first information block, where the first information block indicates a first time unit set. The time unit in which the first reference signal is located is a time unit in the first time unit set, and the first time unit set depends on a spatial relation of the first reference signal resource.

In a sub-embodiment of this embodiment, the first information block is carried by higher layer signaling.

In a sub-embodiment of this embodiment, the first information block is carried by RRC signaling.

In a sub-embodiment of this embodiment, the first signaling includes the first information block.

In a sub-embodiment of this embodiment, the first signaling and the first information block both include RRC signaling, and the first signaling and the first information block include different fields of a same RRC IE.

In a sub-embodiment of this embodiment, the first signaling and the first information block both include RRC signaling, and the first signaling and the first information block belong to different RRC IEs.

In a sub-embodiment of this embodiment, the first information block is transmitted through MAC layer signaling.

In a sub-embodiment of this embodiment, the first information block includes a MAC CE.

In a sub-embodiment of this embodiment, the first information block includes RRC signaling and a MAC CE.

In a sub-embodiment of this embodiment, the first information block is jointly born by RRC signaling and a MAC CE.

In a sub-embodiment of this embodiment, the first signaling includes the first information block.

In a sub-embodiment of this embodiment, the first information block is carried by the first signaling.

In a sub-embodiment of this embodiment, the first information block includes the first signaling.

In a sub-embodiment of this embodiment, the first information block configures the first time unit set.

In a sub-embodiment of this embodiment, the first information block indicates the first time unit set.

In a sub-embodiment of this embodiment, the first information block explicitly indicates the first time unit set.

In a sub-embodiment of this embodiment, the first information block implicitly indicates the first time unit set.

In a sub-embodiment of this embodiment, the explicit indication includes direct configuration.

In a sub-embodiment of this embodiment, the explicit indication includes a direct indication.

In a sub-embodiment of this embodiment, the implicit indication includes an indirect indication by indicating another IE.

In a sub-embodiment of this embodiment, the first information block indicates a time domain location of a time unit included in the first time unit set.

In a sub-embodiment of this embodiment, the first information block indicates a period of a time unit included in the first time unit set.

In a sub-embodiment of this embodiment, the first information block indicates a length of any time unit included in the first time unit set.

In a sub-embodiment of this embodiment, the first information block indicates a quantity of symbols included in any time unit included in the first time unit set.

In a sub-embodiment of this embodiment, the first information block indicates a quantity of slots included in any time unit included in the first time unit set.

In a sub-embodiment of this embodiment, the first information block is transmitted on a physical layer data channel (used for transmitting user data and higher layer signaling).

In a sub-embodiment of this embodiment, a physical layer channel occupied by the first information block includes a PDSCH.

In a sub-embodiment of this embodiment, a transmission channel occupied by the first information block includes a DL-SCH.

In a sub-embodiment of this embodiment, a physical layer channel occupied by the first information block includes a PSCCH.

In a sub-embodiment of this embodiment, the steps in the box F51 are performed before step S510 in FIG. 5.

In a sub-embodiment of this embodiment, the steps in the box F51 are performed after step S520 in FIG. 5.

In a sub-embodiment of this embodiment, step S510 includes step S5110, where step S5110 and step S510 occur simultaneously; and step S520 includes step S5210, where step S5210 and step S520 occur simultaneously.

In an embodiment, the steps in the box F51 in FIG. 5 do not exist.

In a sub-embodiment of this embodiment, the first time unit set is pre-configured.

In a sub-embodiment of this embodiment, the first time unit set is predefined.

In a sub-embodiment of this embodiment, the first time unit set is determined by the first node U1 based on AI (Artificial Intelligence, artificial intelligence)/ML (Machine Learning, machine learning)/DL (Deep Learning, deep learning).

In a sub-embodiment of this embodiment, the first time unit set is determined by the first node U1 based on a sensing signal.

In a sub-embodiment of this embodiment, the first time unit set is determined by the first node U1 through implementation.

In an embodiment, the steps in the box F52 in FIG. 5 exist; and the method applied to the first node U1 in this application includes: receiving the second information block, where the second information block indicates a candidate reference signal resource set. At least one candidate reference signal resource in the candidate reference signal resource set is associated with the first time unit set.

In a sub-embodiment of this embodiment, the second information block is broadcast.

In a sub-embodiment of this embodiment, the second information block is multicast.

In a sub-embodiment of this embodiment, the second information block includes higher layer signaling.

In a sub-embodiment of this embodiment, the second information block is higher layer signaling.

In a sub-embodiment of this embodiment, the second information block is transmitted through RRC signaling.

In a sub-embodiment of this embodiment, the second information block is born by RRC signaling.

In a sub-embodiment of this embodiment, the second information block includes one or more RRC IEs.

In a sub-embodiment of this embodiment, the second information block includes one or more fields in an RRC IE.

In a sub-embodiment of this embodiment, the second information block includes information in all or part of fields of each RRC IE in a plurality of RRC IEs.

In a sub-embodiment of this embodiment, the second information block is transmitted through MAC layer signaling.

In a sub-embodiment of this embodiment, the second information block includes a MAC CE.

In a sub-embodiment of this embodiment, the second information block includes RRC signaling and a MAC CE.

In a sub-embodiment of this embodiment, the second information block is jointly born by RRC signaling and a MAC CE.

In a sub-embodiment of this embodiment, the first signaling includes the second information block.

In a sub-embodiment of this embodiment, both the first signaling and the second information block include RRC signaling, and the first signaling and the second information block include different fields of a same RRC IE.

In a sub-embodiment of this embodiment, both the first signaling and the second information block include RRC signaling, and the first signaling and the second information block belong to different RRC IEs.

In a sub-embodiment of this embodiment, the second information block indicates an index or identifier of the candidate reference signal set.

In a sub-embodiment of this embodiment, the second information block indicates a reference signal resource included in the candidate reference signal set.

In a sub-embodiment of this embodiment, the second information block indicates a purpose (purpose) of the candidate reference signal set.

In a sub-embodiment of this embodiment, the purpose includes at least one of sensing (sensing), a beam failure (beam failure), and a radio link failure (radio link failure).

In a sub-embodiment of this embodiment, the second information block is transmitted on a physical layer data channel (used for transmitting user data and higher layer signaling).

In a sub-embodiment of this embodiment, a physical layer channel occupied by the second information block includes a PDSCH.

In a sub-embodiment of this embodiment, a transmission channel occupied by the second information block includes a DL-SCH.

In a sub-embodiment of this embodiment, a physical layer channel occupied by the second information block includes a PSCCH.

In a sub-embodiment of this embodiment, the steps in the box F51 are performed before step S510 in FIG. 5.

In a sub-embodiment of this embodiment, the steps in the box F51 are performed after step S510 in FIG. 5.

In a sub-embodiment of this embodiment, step S5110 and step S510 occur simultaneously, and step S5210 and step S520 occur simultaneously; step S510 includes step S5110; and step S520 includes step S5210.

In an embodiment, the steps in the box F52 in FIG. 5 do not exist.

In a sub-embodiment of this embodiment, an index or identifier of the candidate reference signal resource set is predefined or preconfigured.

In a sub-embodiment of this embodiment, a reference signal resource included in the candidate reference signal resource set is predefined or preconfigured.

In a sub-embodiment of this embodiment, the candidate reference signal resource set is determined by the first node in an implementation-related manner.

In an embodiment, both the steps in the box F51 and the steps in the box F52 in FIG. 5 exist.

In a sub-embodiment of this embodiment, the steps in the box F51 are performed before the steps in the box F52 in FIG. 5.

In a sub-embodiment of this embodiment, the steps in the box F51 are performed after the steps in the box F52 in FIG. 5.

In a sub-embodiment of this embodiment, step S5110 includes step S5120, and step S5110 and step S5120 occur simultaneously; and step S5120 includes step S5220, and step S5120 and step S5220 occur simultaneously.

In a sub-embodiment of this embodiment, an order of step S5210, step S5220, and step S520 can be arbitrarily combined.

In a sub-embodiment of this embodiment, an order of step S5110, step S5120, and step S510 can be arbitrarily combined.

In an embodiment, neither the steps in the box F51 nor the steps in the box F52 in FIG. 5 exist.

### Embodiment 6

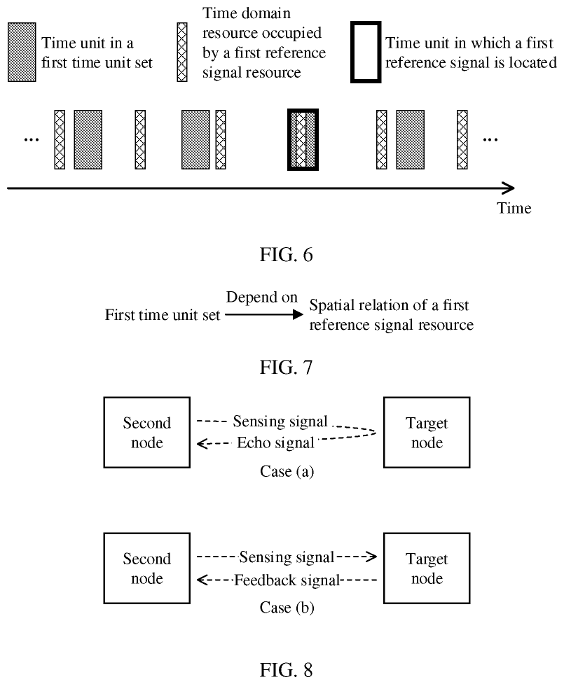

Embodiment 6 illustrates a schematic diagram of a first time unit set according to an embodiment of this application, as shown in FIG. 6. In FIG. 6, a horizontal axis represents time, a cross-filled rectangle represents a time domain resource occupied by a first reference signal resource in terms of time, a gray solid-filled rectangle represents a time unit included in a first time unit set in terms of time, and a black bold-outlined rectangle represents a time unit in which a first reference signal is located in terms of time. It should be noted that the figures in this embodiment are only example descriptions and do not represent a proportional relation between the time unit and the time domain resource occupied by the first reference signal resource in actual implementation.

In Embodiment 6, the time unit in which the first reference signal is located is a time unit in the first time unit set.

In an embodiment, the first reference signal resource occupies a periodic time domain resource.

In an embodiment, the first time unit set includes at least one time unit.

In an embodiment, the first time unit set includes a plurality of time units.

In an embodiment, the first time unit set includes a periodic time unit.

In an embodiment, any time unit included in the first time unit set is consecutive in time domain.

In an embodiment, a time domain resource occupied by the first reference signal belongs to a time unit of the first time unit set.

In an embodiment, the first time unit set includes a time unit occupied by the first reference signal resource.

In an embodiment, the first time unit set includes a time unit not occupied by the first reference signal resource.

In an embodiment, the first time unit set includes a time unit occupied by the first reference signal.

In an embodiment, the first time unit set includes a time unit not occupied by the first reference signal.

In an embodiment, a time domain resource occupied by the first time unit set overlaps with the time domain resource occupied by the first reference signal resource.

In an embodiment, a time domain resource occupied by the first time unit set is not orthogonal to the time domain resource occupied by the first reference signal resource.

In an embodiment, the time unit in which the first reference signal is located is a time unit in the first time unit set.

In an embodiment, the time domain resource occupied by the first reference signal belongs to the time domain resource occupied by the first time unit set.

In an embodiment, the time domain resource occupied by the first reference signal belongs to the time domain resource occupied by the first reference signal resource.

In an embodiment, the time domain resource occupied by the first reference signal belongs to an overlapping time domain resource between the time domain resource occupied by the first reference signal resource and the time domain resource occupied by the first time unit set.

In an embodiment, the first time unit set is a candidate time unit set in this application.

In an embodiment, the first time unit set is a subset of the candidate time unit set in this application.

### Embodiment 7

Embodiment 7 illustrates a 2^{nd} schematic diagram of a first time unit set according to an embodiment of this application, as shown in FIG. 7. In FIG. 7, the first time unit set depends on a spatial relation of a first reference signal resource.

In Embodiment 7, the first time unit set depends on the spatial relation (spatial relation) of the first reference signal resource.

In an embodiment, the first time unit set depends on the spatial relation of the first reference signal resource.

In an embodiment, the spatial relation includes: a QCL relation (relationship).

In an embodiment, the spatial relation includes: a QCL type (type).

In an embodiment, the spatial relation includes: a large-scale characteristic.

In an embodiment, the spatial relation includes: a spatial reception parameter.

In an embodiment, the spatial relation includes: a spatial transmission parameter.

In an embodiment, the spatial relation includes: spatial filtering.

In an embodiment, the spatial relation includes: spatial domain filtering.

In an embodiment, the spatial relation includes: precoding.

In an embodiment, the spatial relation includes: beamforming.

In an embodiment, the spatial relation of the first reference signal resource includes a QCL relation of the first reference signal resource.

In an embodiment, the spatial relation of the first reference signal resource includes QCL information of the first reference signal resource.

In an embodiment, the spatial relation of the first reference signal resource includes a QCL type of the first reference signal resource.

In an embodiment, the spatial relation of the first reference signal resource includes: a signal that is QCL with a reference signal sent in the first reference signal resource.

In an embodiment, the spatial relation of the first reference signal resource includes: a reference signal resource that is QCL with a reference signal sent in the first reference signal resource.

In an embodiment, the spatial relation of the first reference signal resource includes a reference signal resource whose large-scale characteristic is mutually inferable with that experienced by the first reference signal resource in a channel.

In an embodiment, the spatial relation of the first reference signal resource includes: a reference signal resource whose spatial transmission parameter is the same as that of the first reference signal resource.

In an embodiment, the spatial relation of the first reference signal resource includes: a reference signal resource that uses same spatial filtering as the first reference signal resource.

In an embodiment, the spatial relation of the first reference signal resource includes: a reference signal resource that uses same spatial domain filtering as the first reference signal resource.

In an embodiment, the spatial relation of the first reference signal resource includes: a reference signal resource that uses same precoding as the first reference signal resource.

In an embodiment, the spatial relation of the first reference signal resource includes: a reference signal resource that uses a same receive beam as the first reference signal resource.

In an embodiment, the spatial relation of the first reference signal resource includes a reference signal resource that uses a same transmit beam as the first reference signal resource.

In an embodiment, the spatial relation of the first reference signal resource includes: a TCI corresponding to the first reference signal resource.

In an embodiment, the spatial relation of the first reference signal resource includes: a TCI state (state) corresponding to the first reference signal resource.

In an embodiment, the spatial relation of the first reference signal resource includes a TCI-StateId corresponding to the first reference signal resource.

In an embodiment, a TCI state indicates a quasi co-location relation.

In an embodiment, a TCI state indicates one or more reference signal resources.

In an embodiment, a TCI state indicates at least one reference signal resource.

In an embodiment, a TCI state includes a parameter for configuring a QCL relation between DMRS (DeModulation Reference Signals, demodulation reference signal) ports of one or two reference signals and a PDSCH, a DMRS port of a PDCCH, a port of a sensing waveform, or a CSI-RS port of a CSI-RS resource.

In an embodiment, a meaning that the first time unit set depends on the spatial relation of the first reference signal resource includes: a period of the first time unit set depends on the spatial relation of the first reference signal resource.

In an embodiment, a meaning that the first time unit set depends on the spatial relation of the first reference signal resource includes: a length of any time unit included in the first time unit set depends on the spatial relation of the first reference signal resource.

In an embodiment, a meaning that the first time unit set depends on the spatial relation of the first reference signal resource includes: both a period of the first time unit set and a length of any time unit included therein depend on the spatial relation of the first reference signal resource.

In an embodiment, a meaning that the first time unit set depends on the spatial relation of the first reference signal resource includes: the first time unit set is configured for the spatial relation of the first reference signal resource.

In an embodiment, a meaning that the first time unit set depends on the spatial relation of the first reference signal resource includes: the first time unit set is configured by RRC signaling, and the first time unit set is configured per (per) reference signal resource.

In an embodiment, a meaning that the first time unit set depends on the spatial relation of the first reference signal resource includes: the first time unit set is determined based on the spatial relation of the first reference signal resource.

In an embodiment, a meaning that the first time unit set depends on the spatial relation of the first reference signal resource includes: a first information block simultaneously indicates the first time unit set and the spatial relation of the first reference signal resource.

In an embodiment, a meaning that the first time unit set depends on the spatial relation of the first reference signal resource includes: the first time unit set is associated with the spatial relation of the first reference signal resource.

In an embodiment, the spatial transmission parameter in this application includes at least one of a transmit antenna port, a transmit antenna port group, a transmit beam, a transmit analog beamforming matrix, a transmit analog beamforming vector, a transmit beamforming matrix, a transmit beamforming vector, or a spatial domain transmit filter.

In an embodiment, the spatial reception parameter in this application includes at least one of a receive beam, a receive analog beamforming matrix, a receive analog beamforming vector, a receive beamforming matrix, a receive beamforming vector, or a spatial domain receive filter.

In an embodiment, the QCL in this application refers to: Quasi Co-Location, quasi co-location.

In an embodiment, the QCL in this application refers to: Quasi Co-Located, quasi co-located.

In an embodiment, the QCL in this application includes: a QCL parameter.

In an embodiment, the QCL in this application includes: a QCL assumption (assumption).

In an embodiment, the QCL types in this application include a type A, a type B, a type C, and a type D.

In an embodiment, in this application, QCL parameters whose QCL type is the type A include a Doppler shift (Doppler shift), Doppler spread (Doppler spread), an average delay (average delay), and delay spread (delay spread); QCL parameters whose QCL type is the type B include a Doppler shift (Doppler shift) and Doppler spread (Doppler spread); QCL parameters whose QCL type is the type C include a Doppler shift (Doppler shift) and an average delay (average delay); and a QCL parameter whose QCL type is the type D includes a spatial reception parameter (spatial Rx parameter).

In an embodiment, the QCL in this application includes: at least one of a Doppler shift (Doppler shift), Doppler spread (Doppler delay), an average delay (average delay), delay spread (delay spread), a spatial transmission parameter (spatial Tx parameter), or a spatial reception parameter (spatial Rx parameter).

In an embodiment, for specific definitions of the type A, the type B, the type C, and the type D in this application, refer to the clause 5.1.5 (clause 5.1.5) of 3GPP TS (Technical Specification, technical specification) 38.214.

In an embodiment, the large-scale characteristic in this application includes: at least one of an average gain (average gain), Doppler spread (Doppler spread), a Doppler shift (Doppler shift), an average delay (average delay), delay spread (delay spread), or a spatial reception parameter (spatial Rx parameter).

### Embodiment 8

Embodiment 8 illustrates a schematic diagram of two ways for a second node to sense a target node according to an embodiment of this application, as shown in FIG. 8. In FIG. 8, a case (a) indicates that the second node senses the target node based on an echo signal of a sensing signal; and a case (b) indicates that the second node senses the target node based on a feedback signal of the sensing signal.

In Embodiment 8, the second node is a sender of first signaling, and the second node determines a first time unit set based on the sensing signal.

In an embodiment, the second node is the sender of the first signaling.

In an embodiment, the second node is a second node in this application.

In an embodiment, the sensing signal is a signal used by the second node for sensing (sensing).

In an embodiment, the sensing signal is a signal used by the second node for detecting (detecting).

In an embodiment, the sensing signal is a signal used by the second node for tracking (tracking).

In an embodiment, the sensing signal is a signal used by the second node for positioning (positioning).

In an embodiment, the sensing signal is a signal used in 5G-Advance (5G-Advanced) and subsequent systems.

In an embodiment, the sensing signal is a signal adopted in 6G and subsequent systems.

In an embodiment, the second node senses the target node through the sensing signal.

In an embodiment, the second node detects the target node through the sensing signal.

In an embodiment, the second node tracks the target node through the sensing signal.

In an embodiment, the second node positions the target node through the sensing signal.

Typically, the second node sends the sensing signal, and the second node receives the echo signal of the sensing signal.

In an embodiment, the second node senses the target node through the echo signal of the sensing signal.

In an embodiment, the second node detects the target node through the echo signal of the sensing signal.

In an embodiment, the second node tracks the target node through the echo signal of the sensing signal.

In an embodiment, the second node positions the target node through the echo signal of the sensing signal.

In an embodiment, the second node receives the echo signal of the sensing signal through coherent detection.

In an embodiment, the second node receives the echo signal of the sensing signal through correlation detection.

In an embodiment, the second node receives and processes the echo signal of the sensing signal.

In an embodiment, the echo signal of the sensing signal is a signal obtained after the sensing signal is reflected by the target node.

In an embodiment, the reflection in this application refers to: passive reflection.

In an embodiment, the reflection in this application refers to: transparent transmission.

In an embodiment, the reflection in this application refers to: the echo signal is reflected without being processed.

Typically, the second node sends the sensing signal, and the second node receives the feedback signal of the sensing signal.

In an embodiment, the second node senses the target node through the feedback signal of the sensing signal.

In an embodiment, the second node detects the target node through the feedback signal of the sensing signal.

In an embodiment, the second node tracks the target node through the feedback signal of the sensing signal.

In an embodiment, the second node positions the target node through the feedback signal of the sensing signal.

In an embodiment, the target node receives the sensing signal, and sends the feedback signal of the sensing signal to the second node.

In an embodiment, the target node receives the sensing signal, and in response to receiving the sensing signal, sends the feedback signal of the sensing signal to the second node.

In an embodiment, the target node receives and processes the sensing signal, and sends the feedback signal of the sensing signal to the second node.

In an embodiment, the target node reflects the sensing signal, a first node in this application receives a reflected signal of the sensing signal, and sends the feedback signal of the sensing signal to the second node.

In an embodiment, the target node reflects the sensing signal, the first node in this application receives the reflected signal of the sensing signal, and in response to receiving the reflected signal of the sensing signal, sends the feedback signal of the sensing signal to the second node.

In an embodiment, the target node reflects the sensing signal, the first node in this application receives and processes the reflected signal of the sensing signal, and sends the feedback signal of the sensing signal to the second node.

In an embodiment, the processing in this application includes: non-transparent transmission.

In an embodiment, the processing in this application includes: radar detection.

In an embodiment, the processing in this application includes: pulse compression.

In an embodiment, the processing in this application includes: active reflection.

In an embodiment, the processing in this application includes: matched filtering.

In an embodiment, the processing in this application includes: modulation.

In an embodiment, the processing in this application includes: decoding.

In an embodiment, the feedback signal of the sensing signal is a signal sent by the target node or the first node in this application based on a sensing result of the sensing signal.

In a sub-embodiment of this embodiment, a meaning of the signal sent based on the sensing result of the sensing signal includes: indicating the sensing result of the sensing signal.

In a sub-embodiment of this embodiment, a meaning of the signal sent based on the sensing result of the sensing signal includes: including the sensing result of the sensing signal.

In a sub-embodiment of this embodiment, a meaning of the signal sent based on the sensing result of the sensing signal includes: indicating that the sensing signal is received.

In a sub-embodiment of this embodiment, a meaning of the signal sent based on the sensing result of the sensing signal includes: communication parameter configuration and selection performed based on the sensing result of the sensing signal.

In an embodiment, the sensing result in this application includes: the first time unit set.

In an embodiment, the sensing result in this application includes: a location parameter of the target node, for example, at least one of a location, a speed, a distance, and a direction.

In an embodiment, the sensing result in this application includes: a communication parameter of the target node, for example, at least one of a reference signal resource, a QCL parameter, a large-scale parameter, a beam, a spatial parameter, or a spatial domain filter that is QCL with a direction of the target node.

In an embodiment, the sensing result in this application includes: a measurement result of the sensing signal, for example, at least one of signal quality, RSRP (Reference Signal Received Power, reference signal received power), or a SINR (Signal-to-Noise and Interference Ratio, signal to interference plus noise ratio).

In an embodiment, at least one of the sensing signal, the echo signal of the sensing signal, and the feedback signal of the sensing signal is used to determine the first time unit set.

In an embodiment, at least one of the sensing signal, the echo signal of the sensing signal, and the feedback signal of the sensing signal is used to sense the location parameter of the target node.

In an embodiment, at least one of the sensing signal, the echo signal of the sensing signal, and the feedback signal of the sensing signal is used to sense the communication parameter of the target node.

In an embodiment, at least one of the sensing signal, the echo signal of the sensing signal, and the feedback signal of the sensing signal is used to determine the measurement result of the sensing signal.

In an embodiment, the second node determines the first time unit set based on the sensing signal and the echo signal of the sensing signal.

In an embodiment, the second node determines at least one of the moving speed, the distance, the direction, or the location of the target node based on the sensing signal and the echo signal of the sensing signal.

In an embodiment, the second node determines, based on the sensing signal and the echo signal of the sensing signal, at least one of the reference signal resource, the QCL parameter, the large-scale parameter, the beam, the spatial parameter, or the spatial domain filter that is quasi-collocated with the direction of the target node.

In an embodiment, the second node determines the first time unit set based on the feedback signal of the sensing signal.

In an embodiment, the second node determines at least one of the moving speed, the distance, the direction, or the location of the target node based on the feedback signal of the sensing signal.

In an embodiment, the second node determines, based on the feedback signal of the sensing signal, at least one of the reference signal resource, the quasi-collocation parameter, the large-scale parameter, the beam, the spatial parameter, or the spatial domain filter that is quasi-collocated with the direction of the target node.

In an embodiment, the first time unit set is related to a motion trajectory of an object sensed by the second node.

In an embodiment, the first time unit set is a prediction by the second node based on the sensing result in this application.

In an embodiment, the second node sends a sensing signal on a time domain resource occupied by the first time unit set.

In a sub-embodiment of this embodiment, the sensing signal includes a first reference signal.

In a sub-embodiment of this embodiment, the sensing signal is the first reference signal.

In a sub-embodiment of this embodiment, the sensing signal occupies a resource element orthogonal to the first reference signal.

In an embodiment, the second node sends a sensing signal before a time domain resource occupied by the first time unit set.

In a sub-embodiment of this embodiment, the second node configures or indicates the first time unit set for the first node based on the sensing result of the sensing signal.

In an embodiment, the target node is the first node in this application.

In an embodiment, the target node is a communication node different from the second node and the first node in this application.

In an embodiment, the target node is not a communication node.

In an embodiment, the second node and the first node in this application are a communication node.

In an embodiment, the communication node in this application refers to: a node that establishes an RRC connection to the second node.

In an embodiment, the communication node in this application refers to: a node that establishes an RRC connection to the first node in this application.

In an embodiment, the communication node in this application refers to: a node that can or is able to establish an RRC connection to the second node.

In an embodiment, the communication node in this application refers to: a node that can or is able to establish an RRC connection to the first node in this application.

### Embodiment 9

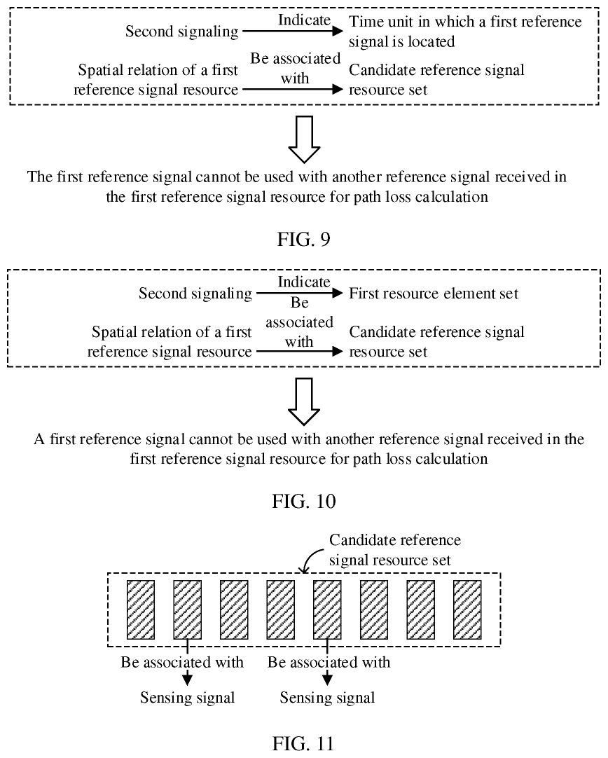

Embodiment 9 illustrates a 1^{st} schematic diagram in which a first reference signal cannot be jointly used with another reference signal received in a first reference signal resource for path loss calculation according to an embodiment of this application, as shown in FIG. 9. In FIG. 9, when second signaling indicates a time unit in which the first reference signal is located, and a spatial relation of the first reference signal resource is associated with a candidate reference signal resource set, the first reference signal cannot be jointly used with the another reference signal received in the first reference signal resource for path loss calculation.

In an embodiment, the second signaling explicitly indicates the time unit in which the first reference signal is located.

In an embodiment, the second signaling implicitly indicates the time unit in which the first reference signal is located.

In an embodiment, a time domain resource occupied by the second signaling indicates the time unit in which the first reference signal is located.

In an embodiment, the second signaling indicates whether the time unit in which the first reference signal is located in a first time unit set is activated.

In an embodiment, the second signaling indicates whether the time unit in which the first reference signal is located in the first time unit set sends a sensing signal.

In an embodiment, the second signaling indicates whether the time unit in which the first reference signal is located in the first time unit set is used for sensing.

In an embodiment, the second signaling indicates at least one time unit in the first time unit set, and the time unit set in which the first reference signal is located belongs to the at least one time unit in the first time unit set indicated by the second signaling.

In an embodiment, the second signaling indicates the time unit in which the first reference signal is located, and the second signaling does not explicitly indicate that the first reference signal cannot be jointly used with the another reference signal received in the first reference signal resource for path loss calculation.

In an embodiment, a meaning that the spatial relation of the first reference signal resource is associated with the candidate reference signal resource set includes: the spatial relation of the first reference signal resource belongs to the candidate reference signal resource set.

In an embodiment, a meaning that the spatial relation of the first reference signal resource is associated with the candidate reference signal resource set includes: a reference signal resource that is QCL with the first reference signal resource belongs to the candidate reference signal resource set.

In an embodiment, a meaning that the spatial relation of the first reference signal resource is associated with the candidate reference signal resource set in this application includes: the first reference signal resource is QCL with at least one reference signal resource in the candidate reference signal resource set.

In an embodiment, a meaning that the spatial relation of the first reference signal resource is associated with the candidate reference signal resource set in this application includes: the first reference signal resource is QCL with a reference signal resource in the candidate reference signal resource set, and a corresponding QCL type includes a type D.

In an embodiment, a meaning that the spatial relation of the first reference signal resource is associated with the candidate reference signal resource set in this application includes: A reference signal resource whose large-scale characteristic is mutually inferable with that experienced by the first reference signal resource set in a channel belongs to the candidate reference signal resource set.

In an embodiment, a meaning that the spatial relation of the first reference signal resource is associated with the candidate reference signal resource set in this application includes: a reference signal resource whose spatial transmission parameter is the same as that of the first reference signal resource belongs to the candidate reference signal resource set.

In an embodiment, a meaning that the spatial relation of the first reference signal resource is associated with the candidate reference signal resource set in this application includes: a reference signal resource that uses same spatial filtering as the first reference signal resource belongs to the candidate reference signal resource set.

In an embodiment, a meaning that the spatial relation of the first reference signal resource is associated with the candidate reference signal resource set in this application includes: a reference signal resource that uses same spatial domain filtering as the first reference signal resource belongs to the candidate reference signal resource set.

In an embodiment, a meaning that the spatial relation of the first reference signal resource is associated with the candidate reference signal resource set in this application includes: a reference signal resource that uses same precoding as the first reference signal resource belongs to the candidate reference signal resource set.

In an embodiment, a meaning that the spatial relation of the first reference signal resource is associated with the candidate reference signal resource set in this application includes: a reference signal resource that uses a same receive beam as the first reference signal resource belongs to the candidate reference signal resource set.

In an embodiment, a meaning that the spatial relation of the first reference signal resource is associated with the candidate reference signal resource set in this application includes: a reference signal resource that uses a same transmit beam as the first reference signal resource belongs to the candidate reference signal resource set.

In an embodiment, a meaning that the spatial relation of the first reference signal resource is associated with the candidate reference signal resource set in this application includes: a TCI indicates that the spatial relation of the first reference signal resource is associated with a reference signal resource in the candidate reference signal resource set.

In an embodiment, a meaning that the spatial relation of the first reference signal resource is associated with the candidate reference signal resource set in this application includes: a TCI indicates that the first reference signal resource is QCL with a reference signal resource in the candidate reference signal resource set.

In an embodiment, a meaning that the spatial relation of the first reference signal resource is associated with the candidate reference signal resource set in this application includes: the first reference signal resource corresponds to a same TCI State as a reference signal resource in the candidate reference signal resource.

In an embodiment, a meaning that the spatial relation of the first reference signal resource is associated with the candidate reference signal resource set in this application includes: the first reference signal resource corresponds to a same TCI-StateId as a reference signal resource in the candidate reference signal resource.

In an embodiment, when the second signaling indicates the time unit in which the first reference signal is located, and the spatial relation of the first reference signal resource is associated with the candidate reference signal resource set, the first reference signal cannot be jointly used with the another reference signal received in the first reference signal resource for path loss calculation.

In an embodiment, when the second signaling indicates the time unit in which the first reference signal is located, the spatial relation of the first reference signal resource is not associated with the candidate reference signal resource set, the first reference signal can be jointly used with the another reference signal received in the first reference signal resource for path loss calculation.

### Embodiment 10

Embodiment 10 illustrates a 2^{nd} schematic diagram in which a first reference signal cannot be jointly used with another reference signal received in a first reference signal resource for path loss calculation according to an embodiment of this application, as shown in FIG. 10. In FIG. 10, second signaling indicates a first resource element set; and the second signaling indicates that a spatial relation of the first reference signal resource is associated with a candidate reference signal resource set, and the first reference signal cannot be jointly used with the another reference signal received in the first reference signal resource for path loss calculation.

In Embodiment 10, a value of a symbol transmitted on a resource element in the first resource element set depends on a first waveform.

In an embodiment, the first resource element set includes a plurality of resource elements.

In an embodiment, the first resource element set corresponds to a plurality of resource elements in a multicarrier symbol.

In an embodiment, the first resource element set occupies one multicarrier symbol in time domain and a plurality of subcarriers in frequency domain.

In a sub-embodiment of this embodiment, the plurality of subcarriers are consecutive in frequency domain.

In a sub-embodiment of this embodiment, the plurality of subcarriers are non-consecutive in frequency domain.

In a sub-embodiment of this embodiment, the plurality of subcarriers are distributed at intervals in frequency domain.

In an embodiment, the first resource element set is used for transmission of a sensing signal.

In an embodiment, a time domain resource occupied by the first resource element set belongs to a first time unit set.

In an embodiment, the time domain resource occupied by the first resource element set is a time unit in the first time unit set.

In an embodiment, the second signaling indicates the first resource element set.

In an embodiment, the second signaling indicates a multicarrier symbol occupied by the first resource element set.

In an embodiment, the second signaling indicates a location in time domain of the multicarrier symbol occupied by the first resource element set.

In an embodiment, the second signaling indicates a 1^{st} subcarrier occupied by the first resource element set in a multicarrier symbol.

In an embodiment, the second signaling indicates a quantity of subcarriers occupied by the first resource element set in a multicarrier symbol.

In an embodiment, the second signaling indicates a subcarrier traversed by the first resource element set in a multicarrier symbol.

In an embodiment, the second signaling indicates density of the first resource element set in a multicarrier symbol.

In an embodiment, a time frequency resource occupied by the second signaling indicates the first resource element set.

In an embodiment, a time domain resource occupied by the second signaling indicates a multicarrier symbol occupied by the first resource element set.

In an embodiment, a frequency domain resource occupied by the second signaling indicates a subcarrier occupied by the first resource element set in a multicarrier symbol.

In an embodiment, the frequency domain resource occupied by the second signaling indicates a 1^{st} subcarrier occupied by the first resource element set in a multicarrier symbol.

In an embodiment, the frequency domain resource occupied by the second signaling indicates a quantity of subcarriers occupied by the first resource element set in a multicarrier symbol.

In an embodiment, the first waveform is a pulse waveform.

In an embodiment, the first waveform is a continuous waveform.

In an embodiment, the first waveform is an FMCW (Frequency Modulated Continuous Wave, frequency modulated continuous wave) waveform.

In an embodiment, the first waveform is an LFMCW (Linear Frequency Modulation Continuous Wave, linear frequency modulated continuous wave) waveform.

In an embodiment, the first waveform is an SFMCW (Step-FMCW, step frequency modulated continuous wave) waveform.

In an embodiment, the first waveform is a TFMCW (Trapezoidal-FMCW, trapezoidal frequency modulated continuous wave) waveform.

In an embodiment, the first waveform is a PRO-FMCW (Pseudo-Random Optimized FMCW, pseudo-random optimized frequency modulated continuous wave) waveform.

In an embodiment, the first waveform is an FMICW (Frequency Modulated Intermittent Continuous Wave, frequency modulated intermittent continuous wave) waveform.

In an embodiment, the first waveform is a PMCW (Phase Modulated Continuous Wave, phase modulated continuous wave) waveform.

In an embodiment, the first waveform is a chirp (Chirp) waveform.

In an embodiment, the first waveform is a PDR (Pulse Doppler Radar, pulse doppler radar) waveform.

In an embodiment, the first waveform is an MFSK (Multiple Frequency Shift Keying, multiple phase shift keying) waveform.

In an embodiment, the first waveform is a fast chirp ramp sequence waveform.

In an embodiment, the first waveform is a waveform used by a second node in this application for sensing (sensing).

In an embodiment, the first waveform is a waveform used by the second node in this application for detecting (detecting).

In an embodiment, the first waveform is a waveform used by the second node in this application for tracking (tracking).

In an embodiment, the first waveform is a waveform used by the second node in this application for positioning (positioning).

In an embodiment, the first waveform is a waveform used in 5G-Advance (5G-Advanced) and subsequent systems.

In an embodiment, the first waveform is a waveform used in 6G and subsequent systems.

In an embodiment, a meaning that the value of the symbol transmitted on the resource element in the first resource element set depends on the first waveform includes: the value of the symbol transmitted on the resource element in the first resource element set is generated by the first waveform.

In an embodiment, a meaning that the value of the symbol transmitted on the resource element in the first resource element set depends on the first waveform includes: the second node in this application generates the value of the symbol transmitted in the resource element in the first resource element set using the first waveform.

In an embodiment, a meaning that the value of the symbol transmitted on the resource element in the first resource element set depends on the first waveform includes: a complex value of the symbol transmitted on the resource element in the first resource element set is generated by the first waveform.

In an embodiment, a meaning that the value of the symbol transmitted on the resource element in the first resource element set depends on the first waveform includes: the second node in this application generates a complex value of the symbol transmitted on the resource element in the first resource element set using the first waveform.

In an embodiment, a meaning that the value of the symbol transmitted on the resource element in the first resource element set depends on the first waveform includes: the symbol transmitted on the resource element in the first resource element set is generated through FFT on an expression of the first waveform in time domain.

In an embodiment, a meaning that the value of the symbol transmitted on the resource element in the first resource element set depends on the first waveform includes: the symbol transmitted on the resource element in the first resource element set is generated through FFT on a sampling point of the first waveform in time domain.

In an embodiment, a meaning that the value of the symbol transmitted on the resource element in the first resource element set depends on the first waveform includes: the second node in this application generates the symbol transmitted on the resource element in the first resource element set using FFT on a sampling point of the first waveform in time domain.

In an embodiment, a meaning that the value of the symbol transmitted on the resource element in the first resource element set depends on the first waveform includes: the symbol transmitted on the resource element in the first resource element set does not carry user information.

In an embodiment, a meaning that the value of the symbol transmitted on the resource element in the first resource element set depends on the first waveform includes: the symbol transmitted on the resource element in the first resource element set is known to a recipient of the first waveform.

In an embodiment, the value of the symbol transmitted on the resource element in the first resource element set is predefined.

In a sub-embodiment of this embodiment, the predefined value is determined by the first waveform.

In an embodiment, the value of the symbol transmitted on the resource element in the first resource element set is obtained by table lookup.

In a sub-embodiment of this embodiment, the value obtained by table lookup is determined by the first waveform.

In an embodiment, the second signaling indicates that the spatial relation of the first reference signal resource is associated with the candidate reference signal resource set.

In an embodiment, the second signaling indicates a TCI state, and the TCI state indicates that the spatial relation of the first reference signal resource is associated with the candidate reference signal resource set.

In an embodiment, the second signaling indicates two TCI states, and one of the two TCI states indicates that the spatial relation of the first reference signal resource is associated with the candidate reference signal resource set.

In an embodiment, the second signaling includes DCI, and the second signaling includes a first field, the first field in the first signaling indicates a TCI state, and the TCI state indicates that the spatial relation of the first reference signal resource is associated with the candidate reference signal resource set.

In an embodiment, the second signaling includes DCI, and the second signaling includes a first field, the first field in the first signaling indicates two TCI states, and one of the two TCI states indicates that the spatial relation of the first reference signal resource is associated with the candidate reference signal resource set.

In an embodiment, when the second signaling indicates the first resource element set, and the second signaling indicates that the spatial relation of the first reference signal resource is associated with the candidate reference signal resource set, the first reference signal cannot be jointly used with the another reference signal received in the first reference signal resource for path loss calculation.

In an embodiment, when the second signaling indicates the first resource element set, and the second signaling indicates that the spatial relation of the first reference signal resource is associated with a candidate reference signal resource set, the first reference signal cannot be jointly used with the other reference signals received in the first reference signal resource for path loss calculation.

In an embodiment, when the second signaling does not indicate the first resource element set, or the second signaling does not indicate that the spatial relation of the first reference signal resource is associated with the candidate reference signal resource set, the first reference signal cannot be jointly used with the another reference signal received in the first reference signal resource for path loss calculation.

In an embodiment, when the second signaling does not indicate the first resource element set, or the second signaling does not indicate that the spatial relation of the first reference signal resource is associated with the candidate reference signal resource set, the first reference signal cannot be jointly used with the another reference signal received in the first reference signal resource for path loss calculation.

In an embodiment, when the second signaling does not indicate the first resource element set, and the second signaling indicates that the spatial relation of the first reference signal resource is associated with the candidate reference signal resource set, the first reference signal can be jointly used with the another reference signal received in the first reference signal resource for path loss calculation.

In an embodiment, when the second signaling does not indicate the first resource element set, and the second signaling indicates that the spatial relation of the first reference signal resource is associated with the candidate reference signal resource set, the first reference signal can be jointly used with the another reference signal received in the first reference signal resource for path loss calculation.

In an embodiment, when the second signaling indicates the first resource element set, and the second signaling indicates that the spatial relation of the first reference signal resource is not associated with the candidate reference signal resource set, the first reference signal can be jointly used with the another reference signal received in the first reference signal resource for path loss calculation.

In an embodiment, when the second signaling indicates the first resource element set, and the second signaling indicates that the spatial relation of the first reference signal resource is not associated with the candidate reference signal resource set, the first reference signal can be jointly used with the another reference signal received in the first reference signal resource for path loss calculation.

### Embodiment 11

Embodiment 11 illustrates a 1^{st} schematic diagram of a candidate reference signal set according to an embodiment of this application, as shown in FIG. 11. In FIG. 11, an upper diagonally filled rectangle represents a reference signal resource in the candidate reference signal resource set. It should be noted that the accompanying drawing in this embodiment is only for example description and does not represent a quantity of reference signal resources that are associated with a sensing signal in the candidate reference signal set and a candidate reference signal set in actual implementation.

In Embodiment 11, at least one candidate reference signal resource included in the candidate reference signal resource set is associated with a sensing signal.

In an embodiment, the candidate reference signal resource set includes K1 reference signal resources, where K1 is a positive integer greater than 1.

In a sub-embodiment of this embodiment, at least one of the K1 reference signal resources is a CSI-RS resource or an SSB.

In a sub-embodiment of this embodiment, at least one of the K1 reference signal resources is a CSI-RS resource.

In a sub-embodiment of this embodiment, at least one of the K1 reference signal resources is a periodic CSI-RS resource.

In a sub-embodiment of this embodiment, at least one of the K1 reference signal resources is an NZP CSI-RS resource.

In a sub-embodiment of this embodiment, at least one of the K1 reference signal resources is an SSB.

In a sub-embodiment of this embodiment, at least one of the K1 reference signal resources corresponds to a TCI State.

In a sub-embodiment of this embodiment, at least one of the K1 reference signal resources corresponds to an RS resource identifier.

In a sub-embodiment of this embodiment, at least one of the K1 reference signal resources corresponds to an NZP-CSI-RS-ResourceId.

In a sub-embodiment of this embodiment, at least one of the K1 reference signal resources corresponds to an SSB-Index.

In a sub-embodiment of this embodiment, at least one of the K1 reference signal resources corresponds to an ssb-Index.

In a sub-embodiment of this embodiment, at least one of the K1 reference signal resources corresponds to a TCI-StateId.

In a sub-embodiment of this embodiment, any one of the K1 reference signal resources is a CSI-RS or an SSB.

In a sub-embodiment of this embodiment, any one of the K1 reference signal resources is a CSI-RS.

In a sub-embodiment of this embodiment, any one of the K1 reference signal resources is a CSI-RS resource.

In a sub-embodiment of this embodiment, any one of the K1 reference signal resources is a periodic CSI-RS resource.

In a sub-embodiment of this embodiment, any one of the K1 reference signal resources is an NZP CSI-RS resource.

In a sub-embodiment of this embodiment, any one of the K1 reference signal resources is an SSB.

In a sub-embodiment of this embodiment, any one of the K1 reference signal resources corresponds to a TCI State.

In a sub-embodiment of this embodiment, any one of the K1 reference signal resources corresponds to an RS resource identifier.

In a sub-embodiment of this embodiment, any one of the K1 reference signal resources corresponds to an NZP-CSI-RS-ResourceId.

In a sub-embodiment of this embodiment, any one of the K1 reference signal resources corresponds to an SSB-Index.

In a sub-embodiment of this embodiment, any one of the K1 reference signal resources corresponds to an ssb-Index.

In a sub-embodiment of this embodiment, any one of the K1 reference signal resources corresponds to a TCI-StateId.

In a sub-embodiment of this embodiment, the K1 reference signal resources are respectively K1 CSI-RS resources or K1 SSBs.

In a sub-embodiment of this embodiment, the K1 reference signal resources are respectively K1 CSI-RS resources.

In a sub-embodiment of this embodiment, the K1 reference signal resources are respectively K1 periodic CSI-RS resources.

In a sub-embodiment of this embodiment, the K1 reference signal resources are respectively K1 NZP CSI-RS resources.

In a sub-embodiment of this embodiment, the K1 reference signal resources are respectively K1 SSBs.

In a sub-embodiment of this embodiment, the K1 reference signal resources respectively correspond to K1 TCI States.

In a sub-embodiment of this embodiment, the K1 reference signal resources respectively correspond to K1 RS resource identifiers.

In a sub-embodiment of this embodiment, the K1 reference signal resources respectively correspond to K1 NZP-CSI-RS-ResourceIds.

In a sub-embodiment of this embodiment, the K1 reference signal resources respectively correspond to K1 SSB-Indexes.

In a sub-embodiment of this embodiment, the K1 reference signal resources respectively correspond to K1 ssb-Indexes.

In a sub-embodiment of this embodiment, the K1 reference signal resources respectively correspond to K1 TCI-StateIds.

In an embodiment, a meaning that the at least one candidate reference signal resource included in the candidate reference signal resource set is associated with the sensing signal includes: each reference signal resource in the at least one candidate reference signal resource included in the candidate reference signal resource set is associated with the sensing signal.

In an embodiment, a meaning that the at least one candidate reference signal resource included in the candidate reference signal resource set is associated with the sensing signal includes: each reference signal resource in the at least one candidate reference signal resource included in the candidate reference signal resource set is associated with a different sensing signal.

In an embodiment, a meaning that the at least one candidate reference signal resource included in the candidate reference signal resource set is associated with the sensing signal includes: each candidate reference signal resource included in the candidate reference signal resource set is associated with the sensing signal.

In an embodiment, a meaning that the at least one candidate reference signal resource included in the candidate reference signal resource set is associated with the sensing signal includes: each candidate reference signal resource included in the candidate reference signal resource set is associated with a different sensing signal.

In an embodiment, a meaning that the at least one candidate reference signal resource included in the candidate reference signal resource set is associated with the sensing signal includes: any candidate reference signal resource included in the candidate reference signal resource set is associated with the sensing signal.

In an embodiment, a meaning that the at least one candidate reference signal resource included in the candidate reference signal resource set is associated with the sensing signal includes: any candidate reference signal resource included in the candidate reference signal resource set is associated with a different sensing signal.

In an embodiment, a meaning that the one candidate reference signal resource is associated with the sensing signal includes: the one candidate reference signal resource is QCL with the sensing signal.

In an embodiment, a meaning that the one candidate reference signal resource is associated with the sensing signal includes: the one candidate reference signal resource is spatially associated with the sensing signal.

In an embodiment, a meaning that the one candidate reference signal resource is associated with the sensing signal includes: the one candidate reference signal resource corresponds to a same TCI State as the sensing signal.

In an embodiment, a meaning that the one candidate reference signal resource is associated with the sensing signal includes: the one candidate reference signal resource corresponds to a same TCI-StateId as the sensing signal.

In an embodiment, a meaning that the one candidate reference signal resource is associated with the sensing signal includes: the one candidate reference signal resource is used for transmission of the sensing signal.

### Embodiment 12

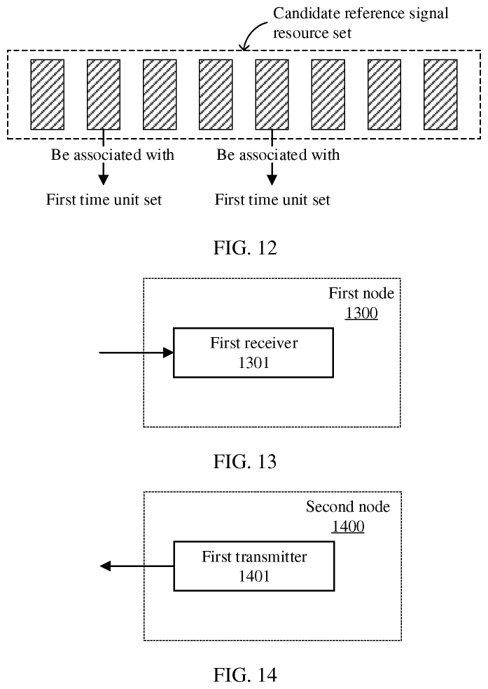

Embodiment 12 illustrates a 2^{nd} schematic diagram of a candidate reference signal resource set according to an embodiment of this application, as shown in FIG. 12. In FIG. 12, an upper diagonally filled rectangle represents a reference signal resource in the candidate reference signal resource set. It should be noted that the accompany drawing in this embodiment is only for example description and does not represent a quantity of reference signal resources that are associated with a first time unit set in the candidate reference signal resource set and a candidate reference signal set in actual implementation.

In Embodiment 12, at least one candidate reference signal resource in the candidate reference signal resource set is associated with the first time unit set.

In an embodiment, a meaning that the at least one candidate reference signal resource in the candidate reference signal resource set is associated with the first time unit set includes: each reference signal resource in the at least one candidate reference signal resource included in the candidate reference signal resource set is associated with the first time unit set.

In an embodiment, a meaning that the at least one candidate reference signal resource in the candidate reference signal resource set is associated with the first time unit set includes: each candidate reference signal resource included in the candidate reference signal resource set is associated with the first time unit set.

In an embodiment, a meaning that the at least one candidate reference signal resource in the candidate reference signal resource set is associated with the first time unit set includes: one candidate reference signal resource in the candidate reference signal resource set is associated with the first time unit set, and the first reference signal resource in this application is associated with the one candidate reference signal resource.

In an embodiment, a meaning that the at least one candidate reference signal resource in the candidate reference signal resource set is associated with the first time unit set includes: any candidate reference signal resource included in the candidate reference signal resource set is associated with the first time unit set.

### Embodiment 13

Embodiment 13 illustrates a block diagram of a structure of a processing apparatus used for a first node according to an embodiment of this application, as shown in FIG. 13. In FIG. 13, the processing apparatus 1300 in the first node includes a first receiver 1301.

In Embodiment 13, the first receiver 1301 receives first signaling, where the first signaling indicates a first reference signal resource; and the first receiver 1301 receives second signaling and a first reference signal, where whether the first reference signal can be jointly used with another reference signal received in the first reference signal resource for path loss calculation depends on the second signaling.

In Embodiment 13, a resource element occupied by the first reference signal in a time unit in which the first reference signal is located belongs to the first reference signal resource.

In an embodiment, the first receiver 1301 receives a first information block, where the first information block indicates a first time unit set. The time unit in which the first reference signal is located is a time unit in the first time unit set, and the first time unit set depends on a spatial relation of the first reference signal resource.

In an embodiment, a sender of the first signaling determines the first time unit set based on a sensing signal.

In an embodiment, when the second signaling indicates the time unit in which the first reference signal is located, and the spatial relation of the first reference signal resource is associated with a candidate reference signal resource set, the first reference signal cannot be jointly used with the another reference signal received in the first reference signal resource for path loss calculation.

In an embodiment, the second signaling indicates a first resource element set, and a value of a symbol transmitted on a resource element in the first resource element set depends on a first waveform; and the second signaling indicates that the spatial relation of the first reference signal resource is associated with the candidate reference signal resource set, and the first reference signal cannot be jointly used with the another reference signal received in the first reference signal resource for path loss calculation.

In an embodiment, at least one candidate reference signal resource included in the candidate reference signal resource set is associated with a sensing signal.

In an embodiment, the first receiver 1301 receives a second information block, where the second information block indicates the candidate reference signal resource set. At least one candidate reference signal resource in the candidate reference signal resource set is associated with the first time unit set.

In an embodiment, when the first reference signal can be jointly used with the another reference signal received in the first reference signal resource for path loss calculation, RSRP, obtained by RSRP determined by measuring the first reference signal and RSRP obtained by measuring the another reference signal passing through a layer-3 filter, is used for path loss calculation.

In an embodiment, the first time unit set includes a periodic time unit.

In an embodiment, the first reference signal is transmitted once based on configuration information of the first reference signal resource.

In an embodiment, the first time unit set includes a time unit occupied by the first reference signal resource.

In an embodiment, the first time unit set includes a time unit not occupied by the first reference signal resource.

In an embodiment, the second signaling indicates whether the time unit in which the first reference signal is located in the first time unit set is activated.

In an embodiment, the second signaling indicates whether the time unit in which the first reference signal is located in the first time unit set sends a sensing signal.

In an embodiment, the second signaling indicates whether the time unit in which the first reference signal is located in the first time unit set is used for sensing.

In an embodiment, the second signaling indicates at least one time unit in the first time unit set, and the time unit set in which the first reference signal is located belongs to the at least one time unit in the first time unit set indicated by the second signaling.

In an embodiment, a time domain resource occupied by the first reference signal belongs to a time unit of the first time unit set.

Typically, the sender of the first signaling sends the sensing signal, and the sender of the first signaling receives an echo signal of the sensing signal.

Typically, the sender of the first signaling sends the sensing signal, and the sender of the first signaling receives a feedback signal of the sensing signal.

In an embodiment, the sender of the first signaling determines the first time unit set based on the sensing signal and the echo signal of the sensing signal.

In an embodiment, the sender of the first signaling determines the first time unit set based on the feedback signal of the sensing signal.

In an embodiment, at least one of the sensing signal, the echo signal of the sensing signal, and the feedback signal of the sensing signal is used to determine the first time unit set.

In an embodiment, the first node is a user equipment.

In an embodiment, the first node is a relay node device.

In an embodiment, the first receiver 1301 includes at least one of the antenna 452, the receiver 454, the multi-antenna receive processor 456, the receive processor 458, the controller/processor 459, the memory 460, and the data source 467 in Embodiment 4.

### Embodiment 14

Embodiment 14 illustrates a block diagram of a structure of a processing apparatus used for a second node according to an embodiment of this application, as shown in FIG. 14. In FIG. 14, the processing apparatus 1400 in the second node includes a first transmitter 1401.

In Embodiment 14, the first transmitter 1401 sends first signaling, where the first signaling indicates a first reference signal resource; and the first transmitter 1401 sends second signaling and a first reference signal, where whether the first reference signal can be jointly used with another reference signal received in the first reference signal resource for path loss calculation depends on the second signaling.

In Embodiment 14, a resource element occupied by the first reference signal in a time unit in which the first reference signal is located belongs to the first reference signal resource.

In an embodiment, the first transmitter 1401 sends a first information block, where the first information block indicates a first time unit set. The time unit in which the first reference signal is located is a time unit in the first time unit set, and the first time unit set depends on a spatial relation of the first reference signal resource.

In an embodiment, the second node 1400 determines the first time unit set based on a sensing signal.

In an embodiment, when the second signaling indicates the time unit in which the first reference signal is located, and the spatial relation of the first reference signal resource is associated with a candidate reference signal resource set, the first reference signal cannot be jointly used with the another reference signal received in the first reference signal resource for path loss calculation.

In an embodiment, the second signaling indicates a first resource element set, and a value of a symbol transmitted on a resource element in the first resource element set depends on a first waveform; and the second signaling indicates that the spatial relation of the first reference signal resource is associated with the candidate reference signal resource set, and the first reference signal cannot be jointly used with the another reference signal received in the first reference signal resource for path loss calculation.

In an embodiment, at least one candidate reference signal resource included in the candidate reference signal resource set is associated with a sensing signal.

In an embodiment, the first transmitter 1401 sends a second information block, where the second information block indicates the candidate reference signal resource set. At least one candidate reference signal resource in the candidate reference signal resource set is associated with the first time unit set.

In an embodiment, when the first reference signal can be jointly used with the another reference signal received in the first reference signal resource for path loss calculation, RSRP, obtained by RSRP determined by measuring the first reference signal and RSRP obtained by measuring the another reference signal passing through a layer-3 filter, is used for path loss calculation.

In an embodiment, the first time unit set includes a periodic time unit.

In an embodiment, the first reference signal is transmitted once based on configuration information of the first reference signal resource.

In an embodiment, the first time unit set includes a time unit occupied by the first reference signal resource.

In an embodiment, the first time unit set includes a time unit not occupied by the first reference signal resource.

In an embodiment, the second signaling indicates whether the time unit in which the first reference signal is located in the first time unit set is activated.

In an embodiment, the second signaling indicates whether the time unit in which the first reference signal is located in the first time unit set sends a sensing signal.

In an embodiment, the second signaling indicates whether the time unit in which the first reference signal is located in the first time unit set is used for sensing.

In an embodiment, the second signaling indicates at least one time unit in the first time unit set, and the time unit in which the first reference signal is located belongs to the at least one time unit in the first time unit set indicated by the second signaling.

In an embodiment, a time domain resource occupied by the first reference signal belongs to a time unit of the first time unit set.

Typically, the second node sends the sensing signal, and the second node receives an echo signal of the sensing signal.

Typically, the second node sends the sensing signal, and the second node receives a feedback signal of the sensing signal.

In an embodiment, the second node determines the first time unit set based on the sensing signal and the echo signal of the sensing signal.

In an embodiment, the second node determines the first time unit set based on the feedback signal of the sensing signal.

In an embodiment, at least one of the sensing signal, the echo signal of the sensing signal, and the feedback signal of the sensing signal is used to determine the first time unit set.

In an embodiment, the second node is a base station device.

In an embodiment, the second node is a user equipment.

In an embodiment, the second node is a relay node device.

In an embodiment, the second node is a maintenance device of a serving cell.

In an embodiment, the second node is a maintenance device of a serving cell of the second node.

In an embodiment, the first transmitter 1401 includes at least one of the antenna 420, the transmitter 418, the transmit processor 416, the multi-antenna transmit processor 471, the controller/processor 475, and the memory 476 in Embodiment 4.

A person of ordinary skill in the art may understand that all or part of the steps of the foregoing methods may be implemented by a program instructing relevant hardware. The program may be stored in a computer-readable storage medium, such as a read-only memory, a hard disk, or an optical disk. Optionally, all or part of the steps of the foregoing embodiments may also be implemented using one or more integrated circuits. Correspondingly, each module unit in the foregoing embodiments may be implemented in a form of hardware, or may be implemented in a form of a software functional module. This application is not limited to any specific combination of software and hardware. The user equipment, the terminal, and the UE in this application include, but are not limited to, drones, communication modules on drones, remote control aircrafts, flying machines, small aircrafts, mobile phones, tablet computers, notebook computers, vehicle-mounted communication devices, vehicles, automobiles, RSUs, wireless sensors, network cards, internet of things terminals, RFID (Radio Frequency Identification, radio frequency identification technology) terminals, NB-IoT (Narrow Band Internet of Things, narrow band internet of things) terminals, MTC (Machine Type Communication, machine type communication) terminals, eMTC (enhanced MTC, enhanced MTC) terminals, data cards, network cards, vehicle-mounted communication devices, low-cost mobile phones, low-cost tablet computers, and another wireless communication device. The base station or system device in this application includes, but is not limited to, a macro cellular base station, a micro cellular base station, a small cellular base station, a femtocell, a relay base station, an eNB (evolved Node B, evolved Node B), a gNB, a TRP, a GNSS (Global Navigation Satellite System, global navigation satellite system), a relay satellite, a satellite base station, an aerial base station, an RSU, a drone, a test device such as a transceiver apparatus or signaling tester simulating some functions of a base station, and another wireless communication device.

A person skilled in the art should understand that the present invention may be implemented in other specific forms without departing from essential or basic characteristics thereof. Therefore, the currently disclosed embodiments should in no way be regarded as restrictive, but rather as illustrative. The scope of the present invention is defined by the appended claims rather than by the foregoing description, and all modifications falling within the equivalent meaning and range thereof are considered to be included therein.

What is claimed is:

1. A first node used for reference signal transmission in wireless communication, comprising:
a first receiver, configured to: receive first signaling, wherein the first signaling indicates a first reference signal resource; and receive second signaling and a first reference signal, wherein whether the first reference signal is capable of being jointly used with another reference signal received in the first reference signal resource for path loss calculation depends on the second signaling; wherein
a resource element occupied by the first reference signal in a time unit in which the first reference signal is located belongs to the first reference signal resource.

2. The first node according to claim 1, wherein
the first receiver is configured to receive a first information block, wherein the first information block indicates a first time unit set; wherein
the time unit in which the first reference signal is located is a time unit in the first time unit set, and the first time unit set depends on a spatial relation of the first reference signal resource.

3. The first node according to claim 2, wherein a sender of the first signaling determines the first time unit set based on a sensing signal.

4. The first node according to claim 1, wherein the second signaling indicates the time unit in which the first reference signal is located, the spatial relation of the first reference signal resource is associated with a candidate reference signal resource set, and the first reference signal is incapable of being jointly used with the another reference signal received in the first reference signal resource for path loss calculation.

5. The first node according to claim 1, wherein the second signaling indicates a first resource element set, and a value of a symbol transmitted on a resource element in the first resource element set depends on a first waveform; and the second signaling indicates that the spatial relation of the first reference signal resource is associated with a candidate reference signal resource set, and the first reference signal is incapable of being jointly used with the another reference signal received in the first reference signal resource for path loss calculation.

6. The first node according to claim 4, wherein at least one candidate reference signal resource comprised in the candidate reference signal resource set is associated with a sensing signal.

7. The first node according to claim 4, wherein
the first receiver, is configured to receive a second information block, wherein the second information block indicates the candidate reference signal resource set; wherein
the at least one candidate reference signal resource in the candidate reference signal resource set is associated with the first time unit set.

8. A second node used for reference signal transmission in wireless communication, comprising:
a first transmitter, configured to: send first signaling, wherein the first signaling indicates a first reference signal resource; and send second signaling and a first reference signal, wherein whether the first reference signal is capable of being jointly used with another reference signal received in the first reference signal resource for path loss calculation depends on the second signaling; wherein
a resource element occupied by the first reference signal in a time unit in which the first reference signal is located belongs to the first reference signal resource.

9. The second node according to claim 8, wherein
the first transmitter, is configured to send a first information block, wherein the first information block indicates a first time unit set; wherein
the time unit in which the first reference signal is located is a time unit in the first time unit set, and the first time unit set depends on a spatial relation of the first reference signal resource.

10. The second node according to claim 9, wherein the second node determines the first time unit set based on a sensing signal.

11. The second node according to claim 8, wherein the second signaling indicates the time unit in which the first reference signal is located, the spatial relation of the first reference signal resource is associated with a candidate reference signal resource set, and the first reference signal is incapable of being jointly used with the another reference signal received in the first reference signal resource for path loss calculation.

12. The second node according to claim 8, wherein the second signaling indicates a first resource element set, and a value of a symbol transmitted on a resource element in the first resource element set depends on a first waveform; and the second signaling indicates that the spatial relation of the first reference signal resource is associated with a candidate reference signal resource set, and the first reference signal is incapable of being jointly used with the another reference signal received in the first reference signal resource for path loss calculation.

13. The second node according to claim 11, wherein at least one candidate reference signal resource comprised in the candidate reference signal resource set is associated with a sensing signal.

14. The second node according to claim 11, wherein
the first transmitter, is configured to send a second information block, wherein the second information block indicates the candidate reference signal resource set; wherein
the at least one candidate reference signal resource in the candidate reference signal resource set is associated with the first time unit set.

15. A method in a first node used for reference signal transmission in wireless communication, comprising:
receiving first signaling, wherein the first signaling indicates a first reference signal resource; and receiving second signaling and a first reference signal, wherein whether the first reference signal is capable of being jointly used with another reference signal received in the first reference signal resource for path loss calculation depends on the second signaling; wherein
a resource element occupied by the first reference signal in a time unit in which the first reference signal is located belongs to the first reference signal resource.

16. The method according to claim 15, comprising:
receiving a first information block, wherein the first information block indicates a first time unit set; wherein
the time unit in which the first reference signal is located is a time unit in the first time unit set, and the first time unit set depends on a spatial relation of the first reference signal resource.

17. The method according to claim 16, wherein a sender of the first signaling determines the first time unit set based on a sensing signal.

18. The method according to claim 15, wherein the second signaling indicates the time unit in which the first reference signal is located, the spatial relation of the first reference signal resource is associated with a candidate reference signal resource set, and the first reference signal is incapable of being jointly used with the another reference signal received in the first reference signal resource for path loss calculation.

19. The method according to claim 15, wherein the second signaling indicates a first resource element set, and a value of a symbol transmitted on a resource element in the first resource element set depends on a first waveform; and the second signaling indicates that the spatial relation of the first reference signal resource is associated with a candidate reference signal resource set, and the first reference signal is incapable of being jointly used with the another reference signal received in the first reference signal resource for path loss calculation.

20. The method according to claim 4, wherein at least one candidate reference signal resource comprised in the candidate reference signal resource set is associated with a sensing signal.
